(19) United States
(12) Patent Application Publication
(10) Pub. No.: US 2026/0082283 A1
(43) Pub. Date: Mar. 19, 2026

(54) METHODS AND APPARATUSES OF A MRO MECHANISM FOR A PCELL CHANGE WITH PSCELL CHANGE PROCEDURE

(71) Applicant: Lenovo (Beijing) Limited, Beijing (CN)

(72) Inventors: Le Yan, Shanghai (CN); Mingzeng Dai, Shanghai (CN); Lianhai Wu, Beijing (CN); Congchi Zhang, Shanghai (CN); Yibin Zhuo, Shanghai (CN)

(73) Assignee: Lenovo (Beijing) Limited, Beijing (CN)

(21) Appl. No.: 19/110,669

(22) PCT Filed: Sep. 27, 2022
(86) PCT No.: PCT/CN2022/121709

§ 371 Date: Mar. 11, 2025

(51) Int. Cl. H04W 36/00

(52) U.S. Cl. CPC H04W 36/0058; H04W 36/00835

(57) ABSTRACT

Embodiments of the present application relate to methods and apparatuses of a mobility robustness optimization (MRO) mechanism for a primary cell (PCell) change with a primary secondary cell (PSCell) change procedure. According to an embodiment of the present application, a source master node (MN) includes a transceiver and a processor coupled to the transceiver; and the processor is configured to transmit a configuration via the transceiver to a user equipment (UE), wherein the configuration is used for storing or reporting one of: a successful handover report (SHR) and a successful PSCell change (SPC) report; and a first report including information regarding a successful completion of a PCell change with PSCell change procedure, and wherein the configuration includes at least one of: first configuration for a set of trigger conditions associated with a master cell group (MCG); or second configuration for a set of trigger conditions associated with a secondary cell group (SCG).

### TECHNICAL FIELD

Embodiments of the present application generally relate to methods and apparatuses of a mobility robustness optimization (MRO) mechanism for a primary cell (PCell) change with a primary secondary cell (PSCell) change procedure.

### BACKGROUND

In a multi-radio dual connectivity (MR-DC) scenario, a user equipment (UE) with multiple transceivers may be configured to utilize resources provided by two different nodes connected via non-ideal backhauls. One node may provide new radio (NR) access and the other one node may provide either evolved-universal terrestrial radio access (UTRA) (E-UTRA) or NR access. One node may act as a master node (MN) and the other node may act as a secondary node (SN). The MN and SN are connected via a network interface (for example, Xn interface or X2 interface as specified in 3rd Generation Partnership Project (3GPP) standard documents), and at least the MN is connected to the core network. MR-DC includes NR-NR DC, EN-DC, NGEN-DC, and/or NE-DC. A MN can be an eNB, a ng-eNB, or a gNB. A SN can be a ng-eNB, an en-gNB, or a gNB.

In general, a PCell change with PSCell change procedure may happen in any MR-DC cases, which includes NR-NR DC, EN-DC, NGEN-DC, NE-DC. A PCell change with PSCell change procedure may be a legacy PCell change with legacy PSCell change procedure, or a legacy PCell change with conditional PSCell addition or change (CPAC) procedure, or a conditional PCell change with legacy PSCell change procedure, or a conditional PCell change with CPAC procedure. In a PCell change with PSCell change procedure, a PCell change includes inter-MN PCell change and/or intra-MN PCell change, and a PSCell change includes inter-SN PSCell change and/or intra-SN PSCell change. For example, a PCell change with PSCell change procedure may be performed in MR-DC with 5GC, e.g., Inter-MN handover with MN initiated SN change procedure as defined in 3GPP TS 37.340.

Currently, in a 3GPP LTE system or 5G system, details regarding a MRO mechanism for a PCell change with a PSCell change procedure have not been discussed yet.

### SUMMARY

Some embodiments of the present application provide a source master node (MN). The source MN includes a transceiver and a processor coupled to the transceiver; and the processor is configured to transmit a configuration via the transceiver to a user equipment (UE), wherein the configuration is used for storing or reporting one of: a successful handover report (SHR) and a successful primary secondary cell (PSCell) change (SPC) report; and a first report including information regarding a successful completion of a primary cell (PCell) change with PSCell change procedure, and wherein the configuration includes at least one of: first configuration for a set of trigger conditions associated with a master cell group (MCG); or second configuration for a set of trigger conditions associated with a secondary cell group (SCG).

In some embodiments, the SHR and the SPC report are two separate reports. In an embodiment, the SHR includes successful PCell change related information, and the SPC report includes successful PSCell change related information. In some other embodiments, the SHR includes the SPC report, i.e., the SPC report is a part of the SHR. In an embodiment, the SHR includes both successful PCell change related information and successful PSCell change related information.

In some embodiments, the set of trigger conditions associated with the MCG includes at least one of: one or more trigger conditions for the SHR; or one or more trigger conditions for the first report.

In some embodiments, the set of trigger conditions associated with the SCG includes at least one of: one or more trigger conditions for the SPC report; or one or more trigger conditions for the first report.

In some embodiments, the configuration includes at least one of: one or more common trigger thresholds configured for both the set of trigger conditions associated with the MCG and the set of trigger conditions associated with the SCG; or one or more trigger thresholds configured separately for the set of trigger conditions associated with the MCG and the set of trigger conditions associated with the SCG.

In some embodiments, the processor of the source MN is configured to transmit, via the transceiver to the UE, an explicit or implicit indication for indicating that the one or more common trigger thresholds are configured for both the set of trigger conditions associated with the MCG and the set of trigger conditions associated with the SCG.

In some embodiments, the configuration includes at least one of: a timer T310 related threshold for a source PCell; a timer T310 related threshold for a source PSCell; a timer T310 related common threshold for the source PCell and the source PSCell; a timer T312 related threshold associated with a measurement identity of a target PCell; a timer T312 related threshold associated with a measurement identity of a target PSCell; a timer T312 related common threshold associated with the measurement identity of the target PCell and the measurement identity of the target PSCell; a timer T304 related threshold for the target PCell; a timer T304 related threshold for the target PSCell; or a timer T304 related common threshold for the target PCell and the target PSCell.

In some embodiments, the processor of the source MN is configured to receive a handover (HO) request acknowledgement (ACK) message including the configuration via the transceiver from a target MN.

In some embodiments, the processor of the source MN is configured to receive a first indication via the transceiver from a target MN, and the first indication indicates that the second configuration for the set of trigger conditions associated with the SCG needs to be configured.

In some embodiments, the processor of the source MN is configured to perform at least one of: generating the second configuration for the set of trigger conditions associated with the SCG; or transmitting a second indication via the transceiver to a source secondary node (SN), wherein the second indication indicates that the source SN needs to configure the second configuration for the set of trigger conditions associated with the SCG.

In some embodiments, the processor of the source MN is configured to receive a SN release request acknowledgement (ACK) message or a SgNB release request ACK message via the transceiver from the source SN, wherein the SN release request ACK message or the SgNB release request ACK message includes the second configuration.

In some embodiments, the processor of the source MN is configured to receive, via the transceiver from a target MN, at least one of: a cell radio network temporary identifier (C-RNTI) of a target PCell; an indication for indicating that the SHR and the SPC report are related to a same PCell change with PSCell change procedure; or first time information related to at least one of the SHR or the SPC report.

In some embodiments, the processor of the source MN is configured to receive, via the transceiver from a target MN, at least one of: a cell radio network temporary identifier (C-RNTI) of a target PCell; an indication for indicating that the SHR and SCG failure related information are related to a same PCell change with PSCell change procedure; or second time information related to at least one of the SHR or the SCG failure related information.

In some embodiments, the processor of the source MN is configured to: receive the SHR and the SPC report via the transceiver from a target MN; and determine whether the SHR and the SPC report are related to a same PCell change with PSCell change procedure.

In some embodiments, the SHR is received prior to the SPC report, or the SHR and the SPC report are received together.

In some embodiments, at least one of the SHR or the SPC report includes first information, and the processor of the source MN is configured to determine whether the SHR and the SPC report are related to the same PCell change with PSCell change procedure based on the first information.

In some embodiments, the first information includes at least one of: a C-RNTI of a target PCell; a C-RNTI of a source PCell; an indication for indicating that the SHR and the SPC report are related to the same PCell change with PSCell change procedure; or first time information related to at least one of the SHR or the SPC report.

In some embodiments, the first time information includes at least one of: absolute time of generating the SPC report; or a time interval between absolute time of generating the SHR and the absolute time of generating the SPC report.

In some embodiments, the processor of the source MN is configured to: start a first timer upon receiving the SHR from the target MN; and determine that the SHR and the SPC report are related to a same PCell change with PSCell change procedure upon receiving the SPC before expiry of the first timer.

In some embodiments, the processor of the source MN is configured to: receive a SHR and SCG failure related information via the transceiver from a target MN; and determine whether the SHR and the SCG failure related information are related to a same PCell change with PSCell change procedure.

In some embodiments, the SHR is received prior to the SCG failure related information, or the SHR and the SCG failure related information are received together.

In some embodiments, at least one of the SHR or the SCG failure related information includes second information, and the processor of the source MN is configured to determine whether the SHR and the SCG failure related information are related to the same PCell change with PSCell change procedure based on the second information.

In some embodiments, the second information includes at least one of: a C-RNTI of a target PCell; a C-RNTI of a source PCell; an indication for indicating that the SHR and the SCG failure related information are associated with the same PCell change with PSCell change procedure; or second time information related to at least one of the SHR or the SCG failure related information.

In some embodiments, the second time information includes at least one of: absolute time of generating the SCG failure related information; or a time interval between absolute time of generating the SHR and the absolute time of generating the SCG failure related information.

In some embodiments, the processor of the source MN is configured to: start a second timer upon receiving the SHR from the target MN; and determine that the SHR and the SCG failure related information are related to a same PCell change with PSCell change procedure upon receiving the SCG failure related information before expiry of the second timer.

Some embodiments of the present application also provide a target master node (MN). The target MN includes a transceiver and a processor coupled to the transceiver; and the processor is configured to perform at least one of: transmitting a configuration via the transceiver to a source MN, wherein the configuration is used for storing or reporting at least one of: a successful primary secondary cell (PSCell) change (SPC) report, or a first report including information regarding a successful completion of a primary cell (PCell) change with PSCell change procedure; and wherein the configuration includes second configuration for a set of trigger conditions associated with a secondary cell group (SCG); and transmitting a first indication via the transceiver to the source MN, wherein the first indication indicates that the second configuration for the set of trigger conditions associated with the SCG needs to be configured.

In some embodiments, the set of trigger conditions associated with the SCG includes at least one of: one or more trigger conditions for the SPC report; or one or more trigger conditions for the first report.

In some embodiments, the configuration further includes first configuration for a set of trigger conditions associated with a master cell group (MCG), and the first configuration is used for storing or reporting at least one of: a successful handover report (SHR), or the first report.

In some embodiments, the SHR and the SPC report are two separate reports. In an embodiment, the SHR includes successful PCell change related information, and the SPC report includes successful PSCell change related information. In some other embodiments, the SHR includes the SPC report, i.e., the SPC report is a part of the SHR. In an embodiment, the SHR includes both successful PCell change related information and successful PSCell change related information.

In some embodiments, the set of trigger conditions associated with the MCG includes at least one of: one or more trigger conditions for the SHR; or one or more trigger conditions for the first report.

In some embodiments, the configuration includes at least one of: one or more common trigger thresholds configured for both the set of trigger conditions associated with the MCG and the set of trigger conditions associated with the SCG; or one or more trigger thresholds configured separately for the set of trigger conditions associated with the MCG and the set of trigger conditions associated with the SCG.

In some embodiments, the configuration includes at least one of: a timer T312 related threshold associated with a measurement identity of a target PCell; a timer T312 related threshold associated with a measurement identity of a target PSCell; a timer T312 related common threshold associated with the measurement identity of the target PCell and the measurement identity of the target PSCell; a timer T304 related threshold for the target PCell; a timer T304 related threshold for the target PSCell; or a timer T304 related common threshold for the target PCell and the target PSCell.

In some embodiments, the configuration is included in a handover (HO) request acknowledgement (ACK) message.

In some embodiments, the processor of the target MN is configured to transmit, via the transceiver to the source MN, at least one of: a cell radio network temporary identifier (C-RNTI) of a target PCell; an indication for indicating that the SHR and the SPC report are related to a same PCell change with PSCell change procedure; or first time information related to at least one of the SHR or the SPC report.

In some embodiments, the processor of the target MN is configured to transmit, via the transceiver to the source MN, at least one of: a cell radio network temporary identifier (C-RNTI) of a target PCell; an indication for indicating that the SHR and SCG failure related information are related to a same PCell change with PSCell change procedure; or second time information related to at least one of the SHR or the SCG failure related information.

In some embodiments, the processor of the target MN is configured to: receive the SHR and the SPC report via the transceiver from the UE; and determine whether the SHR and the SPC report are related to a same PCell change with PSCell change procedure.

In some embodiments, the processor of the target MN is configured to: start a first timer upon receiving the SHR from the UE; and determine that the SHR and the SPC report are related to a same PCell change with PSCell change procedure upon receiving the SPC report before expiry of the first timer.

In some embodiments, the processor of the target MN is configured to transmit the SHR and the SPC report via the transceiver to the source MN, and the SHR is transmitted prior to the SPC report, or the SHR and the SPC report are transmitted together.

In some embodiments, at least one of the SHR or the SPC report includes first information, and the processor of the target MN is configured to determine whether the SHR and the SPC report are related to the same PCell change with PSCell change procedure based on the first information.

In some embodiments, the first information includes at least one of: a C-RNTI of a target PCell; a C-RNTI of a source PCell; an indication for indicating that the SHR and the SPC report are related to the same PCell change with PSCell change procedure; or first time information related to at least one of the SHR or the SPC report.

In some embodiments, the first time information includes at least one of: absolute time of generating the SPC report; or a time interval between absolute time of generating the SHR and the absolute time of generating the SPC report.

In some embodiments, the processor of the target MN is configured to: receive a SHR and SCG failure information message via the transceiver from the UE; and determine whether the SHR and the SCG failure information message are related to a same PCell change with PSCell change procedure.

In some embodiments, the SHR is received prior to the SCG failure information message, or the SHR and the SCG failure information message are received together.

In some embodiments, the processor of the target MN is configured to: start a second timer upon receiving the SHR from the UE; and determine that the SHR and the SCG failure information message are related to a same PCell change with PSCell change procedure upon receiving the SCG failure information message before expiry of the second timer.

In some embodiments, the processor of the target MN is configured to transmit the SHR and SCG failure related information via the transceiver to the source MN, wherein the SHR is transmitted prior to the SCG failure related information, or the SHR and the SCG failure related information are transmitted together.

In some embodiments, at least one of the SHR or the SCG failure information message includes second information, and the processor of the target MN is configured to determine whether the SHR and the SCG failure information message are related to the same PCell change with PSCell change procedure based on the second information.

In some embodiments, the second information includes at least one of: a C-RNTI of a target PCell; a C-RNTI of a source PCell; an indication for indicating that the SHR and the SCG failure information message are related to the same PCell change with PSCell change procedure; or second time information related to at least one of the SHR or the SCG failure information message.

In some embodiments, the second time information includes at least one of: absolute time of generating the SCG failure information message; or a time interval between absolute time of generating the SHR and the absolute time of generating the SCG failure information message.

Some embodiments of the present application also provide a source secondary node (SN). The source SN includes a transceiver and a processor coupled to the transceiver; and the processor is configured to receive an indication via the transceiver from a source master node (MN), wherein the indication indicates that the source SN needs to configure a second configuration for a set of trigger conditions associated with a secondary cell group (SCG).

In some embodiments, the set of trigger conditions associated with the SCG includes at least one of: one or more trigger conditions for a successful primary secondary cell (PSCell) change (SPC) report; or one or more trigger conditions for a first report including information regarding a successful completion of a primary cell (PCell) change with PSCell change procedure.

In some embodiments, the processor of the source SN is configured to receive, via the transceiver from the source MN, at least one of: a cell radio network temporary identifier (C-RNTI) of a target PCell; an indication for indicating that a successful handover report (SHR) and a SPC report are related to a same PCell change with PSCell change procedure; or first time information related to at least one of the SHR or the SPC report.

In some embodiments, the SHR and the SPC report are two separate reports. In an embodiment, the SHR includes successful PCell change related information, and the SPC report includes successful PSCell change related information. In some other embodiments, the SHR includes the SPC report, i.e., the SPC report is a part of the SHR. In an embodiment, the SHR includes both successful PCell change related information and successful PSCell change related information.

In some embodiments, the first time information includes at least one of: absolute time of generating the SPC report; or a time interval between absolute time of generating the SHR and the absolute time of generating the SPC report.

In some embodiments, the processor of the source SN is configured to receive, via the transceiver from the source MN, at least one of: a cell radio network temporary identifier (C-RNTI) of a target PCell; an indication for indicating that a successful handover report (SHR) and SCG failure related information are related to a same PCell change with PSCell change procedure; or second time information related to at least one of the SHR or the SCG failure related information.

In some embodiments, the second time information includes at least one of: absolute time of generating the SCG failure related information; or a time interval between absolute time of generating the SHR and the absolute time of generating the SCG failure related information.

In some embodiments, the processor of the source SN is configured to transmit, via the transceiver to the source MN, a SN release request acknowledgement (ACK) message or SgNB release request ACK message including the second configuration for the set of trigger conditions associated with the SCG.

In some embodiments, the second configuration includes at least one of: a timer T310 related threshold for a source PSCell; timer T312 related threshold associated with a measurement identity of a target PSCell; or a timer T304 related threshold for the target PSCell.

Some embodiments of the present application also provide a user equipment (UE). The UE includes a transceiver and a processor coupled to the transceiver; and the processor is configured to receive a configuration via the transceiver from a source master node (MN), wherein the configuration is used for storing or reporting one of: a successful handover report (SHR) and a successful primary secondary cell (PSCell) change (SPC) report; and a first report including information regarding a successful completion of a primary cell (PCell) change with PSCell change procedure, and wherein the configuration includes at least one of: first configuration for a set of trigger conditions associated with a master cell group (MCG); or second configuration for a set of trigger conditions associated with a secondary cell group (SCG).

In some embodiments, the SHR and the SPC report are two separate reports. In an embodiment, the SHR includes successful PCell change related information, and the SPC report includes successful PSCell change related information. In some other embodiments, the SHR includes the SPC report, i.e., the SPC report is a part of the SHR. In an embodiment, the SHR includes both successful PCell change related information and successful PSCell change related information.

In some embodiments, the set of trigger conditions associated with the MCG includes at least one of: one or more trigger conditions for the SHR; or one or more trigger conditions for the first report.

In some embodiments, the set of trigger conditions associated with the SCG includes at least one of: one or more trigger conditions for the SPC report; or one or more trigger conditions for the first report.

In some embodiments, the configuration includes at least one of: one or more common trigger thresholds configured for both the set of trigger conditions associated with the MCG and the set of trigger conditions associated with the SCG; or one or more trigger thresholds configured separately for the set of trigger conditions associated with the MCG and the set of trigger conditions associated with the SCG.

In some embodiments, the processor of the UE is configured to receive, via the transceiver from the source MN, an explicit or implicit indication for indicating that the one or more common trigger thresholds are configured for both the set of trigger conditions associated with the MCG and the set of trigger conditions associated with the SCG.

In some embodiments, the configuration includes at least one of: a timer T310 related threshold for a source PCell; a timer T310 related threshold for a source PSCell; a timer T310 related common threshold for the source PCell and the source PSCell; a timer T312 related threshold associated with a measurement identity of a target PCell; a timer T312 related threshold associated with a measurement identity of a target PSCell; a timer T312 related common threshold associated with the measurement identity of the target PCell and the measurement identity of the target PSCell; a timer T304 related threshold for the target PCell; a timer T304 related threshold for the target PSCell; or a timer T304 related common threshold for the target PCell and the target PSCell.

In some embodiments, the processor of the UE is configured to: in response to at least one trigger condition for the SHR being fulfilled before fulfillment of at least one trigger condition for the SPC report, transmit the SHR or check whether the at least one trigger condition for the SPC report is fulfilled before transmitting the SHR; and in response to the at least one trigger condition for the SPC report being fulfilled before fulfillment of the at least one trigger condition for the SHR report, check whether the at least one trigger condition for the SHR is fulfilled before transmitting the SPC report.

In some embodiments, in response to transmitting the SHR, the processor of the UE is configured to store at least one of following in the SPC report upon fulfillment of the at least one trigger condition for the SPC report: a cell radio network temporary identifier (C-RNTI) of a target PCell; an indication for indicating that the SHR and the SPC report are related to a same PCell change with PSCell change procedure; or first time information related to at least one of the SHR or the SPC report.

In some embodiments, the first time information includes at least one of: absolute time of generating the SPC report; or a time interval between absolute time of generating the SHR and the absolute time of generating the SPC report.

In some embodiments, in response to checking whether the at least one trigger condition for the SPC report is fulfilled before transmitting the SHR, the processor of the UE is configured to: transmit the SHR together with the SPC report, in response to fulfillment of the at least one trigger condition for the SPC report and in response to the successful completion of the PCell change with PSCell change procedure; and only transmit the SHR, in response to unfulfillment of the at least one trigger condition for the SPC report and in response to the successful completion of the PCell change with PSCell change procedure.

In some embodiments, in response to checking whether the at least one trigger condition for the SHR is fulfilled before transmitting the SPC report, the processor of the UE is configured to: transmit the SPC report together with the SHR, in response to fulfillment of the at least one trigger condition for the SHR and in response to the successful completion of the PCell change with PSCell change procedure; and release the SPC report, in response to at least one of: a random access (RA) procedure to the target PCell fails, or a RA procedure to the target PSCell fails.

In some embodiments, the processor of the UE is configured to store information regarding the successful completion of the PCell change with PSCell change procedure in the first report, in response to fulfillment of at least one trigger condition within the set of trigger conditions associated with the MCG and fulfillment of at least one trigger condition within the set of trigger conditions associated with the SCG.

In some embodiments, the processor of the UE is configured to transmit the first report via the transceiver in response to the successful completion of the PCell change with PSCell change procedure.

In some embodiments, the first report is transmitted to a target MN, and the first report is transferred by the target MN to at least one of: the source MN; the target SN; or the source SN.

In some embodiments, the first report includes at least one of: information associated with a source PCell and a source PSCell; information associated with a target PCell and a target PSCell; a cause value of the first report; random access (RA) information towards the target PCell; or RA information towards the target PSCell.

Some embodiments of the present application provide a method performed by a source MN. The method includes transmitting a configuration to a user equipment (UE), wherein the configuration is used for storing or reporting one of: a successful handover report (SHR) and a successful primary secondary cell (PSCell) change (SPC) report; and a first report including information regarding a successful completion of a primary cell (PCell) change with PSCell change procedure, and wherein the configuration includes at least one of: first configuration for a set of trigger conditions associated with a master cell group (MCG); or second configuration for a set of trigger conditions associated with a secondary cell group (SCG).

Some embodiments of the present application provide a method performed by a target MN. The method includes performing one of: transmitting a configuration to a source MN, wherein the configuration is used for storing or reporting at least one of: a successful primary secondary cell (PSCell) change (SPC) report, or a first report including information regarding a successful completion of a primary cell (PCell) change with PSCell change procedure; and wherein the configuration includes second configuration for a set of trigger conditions associated with a secondary cell group (SCG); and transmitting a first indication to the source MN, wherein the first indication indicates that the second configuration for the set of trigger conditions associated with the SCG needs to be configured.

Some embodiments of the present application provide a method performed by a source SN. The method includes receiving an indication from a source master node (MN), wherein the indication indicates that the source SN needs to configure a second configuration for a set of trigger conditions associated with a secondary cell group (SCG).

Some embodiments of the present application provide a method performed by a UE. The method includes receiving a configuration via the transceiver from a source master node (MN), wherein the configuration is used for storing or reporting one of: a successful handover report (SHR) and a successful primary secondary cell (PSCell) change (SPC) report; and a first report including information regarding a successful completion of a primary cell (PCell) change with PSCell change procedure, and wherein the configuration includes at least one of: first configuration for a set of trigger conditions associated with a master cell group (MCG); or second configuration for a set of trigger conditions associated with a secondary cell group (SCG).

Some embodiments of the present application provide an apparatus for wireless communications. The apparatus comprises: a non-transitory computer-readable medium having stored thereon computer-executable instructions; a receiving circuitry; a transmitting circuitry; and a processor coupled to the non-transitory computer-readable medium, the receiving circuitry and the transmitting circuitry, wherein the computer-executable instructions cause the processor to implement the abovementioned method performed by a network node (a source MN, a target MN, or a source SN) or a UE.

The details of one or more examples are set forth in the accompanying drawings and the descriptions below. Other features, objects, and advantages will be apparent from the descriptions and drawings, and from the claims.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 illustrates a schematic diagram of a wireless communication system in accordance with some embodiments of the present application.

FIGS. 2-5 illustrate exemplary flowcharts of transmitting SHR in accordance with some embodiments of the present application.

FIG. 6 illustrates an exemplary flowchart of transmitting a report including information regarding a successful completion of a PCell change with PSCell change procedure in accordance with some embodiments of the present application.

FIG. 7 illustrates a block diagram of an exemplary apparatus in accordance with some embodiments of the present application.

### DETAILED DESCRIPTION

The detailed description of the appended drawings is intended as a description of preferred embodiments of the present application and is not intended to represent the only form in which the present application may be practiced. It should be understood that the same or equivalent functions may be accomplished by different embodiments that are intended to be encompassed within the spirit and scope of the present application.

Reference will now be made in detail to some embodiments of the present application, examples of which are illustrated in the accompanying drawings. To facilitate understanding, embodiments are provided under specific network architecture and new service scenarios, such as 3GPP 5G, 3GPP LTE Release 8 and so on. It is contemplated that along with developments of network architectures and new service scenarios, all embodiments in the present application are also applicable to similar technical problems; and moreover, the terminologies recited in the present application may change, which should not affect the principle of the present application.

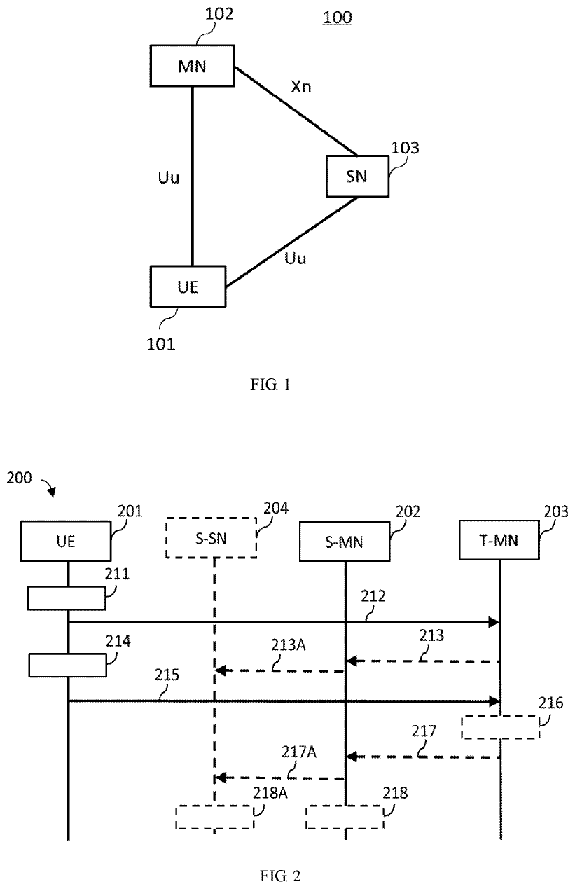

FIG. 1 illustrates a schematic diagram of a wireless communication system in accordance with some embodiments of the present application.

As shown in FIG. 1, the wireless communication system 100 may be a dual connectivity system 100, including at least one UE 101, at least one MN 102, and at least one SN 103. In particular, the dual connectivity system 100 in FIG. 1 includes one shown UE 101, one shown MN 102, and one shown SN 103 for illustrative purpose. Although a specific number of UEs 101, MNs 102, and SNs 103 are depicted in FIG. 1, it is contemplated that any number of UEs 101, MNs 102, and SNs 103 may be included in the wireless communication system 100.

Referring to FIG. 1, UE 101 may be connected to MN 102 and SN 103 via a network interface, for example, the Uu interface as specified in 3GPP standard documents. MN 102 and SN 103 may be connected with each other via a network interface, for example, the Xn interface as specified in 3GPP standard documents for NR-NR DC or NGEN-DC or NE-DC, or X2 interface as specified in 3GPP standard documents for EN-DC. MN 102 may be connected to the core network via a network interface (not shown in FIG. 1). UE 102 may be configured to utilize resources provided by MN 102 and SN 103 to perform data transmission.

MN 102 may refer to a radio access node that provides a control plane connection to the core network. In an embodiment of the present application, in the E-UTRA-NR Dual Connectivity (EN-DC) scenario, MN 102 may be an eNB. In another embodiment of the present application, in the next generation E-UTRA-NR Dual Connectivity (NGEN-DC) scenario, MN 102 may be an ng-eNB. In yet another embodiment of the present application, in the NR-E-UTRA Dual Connectivity (NE-DC) scenario or the NR-NR Dual Connectivity (NR-DC) scenario, MN 102 may be a gNB.

MN 102 may be associated with a master cell group (MCG). The MCG may refer to a group of serving cells associated with MN 102, and may include a primary cell (PCell) and optionally one or more secondary cells (SCells) of the MCG. The PCell may provide a control plane connection to UE 101.

SN 103 may refer to a radio access node without a control plane connection to the core network but providing additional resources to UE 101. In an embodiment of the present application, in the EN-DC scenario, SN 103 may be an en-gNB. In another embodiment of the present application, in the NE-DC scenario, SN 103 may be a ng-eNB. In yet another embodiment of the present application, in the NR-DC scenario or the NGEN-DC scenario, SN 103 may be a gNB.

SN 103 may be associated with a secondary cell group (SCG). The SCG may refer to a group of serving cells associated with SN 103, and may include a primary secondary cell (PSCell) and optionally one or more secondary cells (SCells). The PCell of the MCG and the PSCell of the SCG may also be referred to as a special cell (SpCell).

In some embodiments of the present application, UE 101 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. In some other embodiments of the present application, UE 101 may include a portable wireless communication device, a smart phone, a cellular telephone, a flip phone, a device having a subscriber identity module, a personal computer, a selective call receiving circuitry, or any other device that is capable of sending and receiving communication signals on a wireless network.

In some other embodiments of the present application, UE 101 may include wearable devices, such as smart watches, fitness bands, optical head-mounted displays, or the like. Moreover, UE 101 may be referred to as a subscriber unit, a mobile, a mobile station, a user, a terminal, a mobile terminal, a wireless terminal, a fixed terminal, a subscriber station, a user terminal, or a device, or described using other terminology used in the art.

In 3GPP Rel-17, Successful Handover Report (SHR) is introduced for MRO of a PCell change procedure. The PCell change may be a legacy PCell change or a handover or a conditional PCell change or a condition handover (CHO). In particular, a MRO function in NR could be enhanced to provide a more robust mobility via reporting failure events observed during successful handovers from source NG-RAN to target NG-RAN by a SHR. A SHR is a report associated with a successful handover comprising a set of measurements collected during the handover phase, i.e., measurement at the handover trigger, measurement at the end of handover execution or measurement after handover execution. For example, a UE could store successful PCell change related information or generates the VarSuccessHO-Report/SHR when at least one of the following trigger conditions is satisfied and/or RA to PCell is successful:
(1) The ratio between the value of the elapsed time of the timer T310 of source PCell and the configured value of the timer T310 configured for source PCell while the UE was connected to the source PCell before executing the last PCell change/HO procedure, is greater than a configured threshold (e.g., thresholdPercentageT310 configured by the source PCell before executing the last PCell change/HO procedure).
(2) If the T312 associated with the measurement identity of the target PCell was running at the time of initiating the execution of the PCell change/HO procedure, and if the ratio between the value of the elapsed time of the timer T312 and the configured value of the timer T312 (which is configured while the UE was connected to the source PCell before executing the last PCell change/HO procedure), is greater than a configured threshold (e.g., thresholdPercentageT312 configured by the source PCell before executing the last PCell change/HO procedure).
(3) The ratio between the value of the elapsed time of the elapsed timer T304 of target PCell and the configured value of the timer T304 (i.e., which is included in the last applied RRCReconfiguration message including the reconfiguration WithSync for PCell change/HO procedure), is greater than a configured threshold (e.g., thresholdPercentageT304 configured by the target PCell before executing the last PCell change/HO procedure).

Successful PCell change related information is included in a SHR, for example, at least one of: cell information of the source PCell, cell information of the target PCell, cause value for SHR (e.g., t304-cause, t310-cause, or t312-cause), measurement results of source PCell and/or target PCell when HO is executed or successful, and RA information (e.g., RACH configurations for target PCell). In general, cell information includes global cell identity and tracking area code of the cell, or PCI and frequency information (e.g. ARFCN).

The availability of a SHR may be indicated by the Handover Complete message (RRCReconfigurationComplete) transmitted from UE to target NG-RAN node over RRC. The target NG-RAN node may fetch information of a successful handover report via UE Information Request/Response mechanism. In addition, the target NG-RAN node could then forward the SHR to the source NR-RAN node to indicate failures experienced during a successful handover event.

Upon reception of a SHR, the receiving node is able to analyse whether its mobility configuration needs adjustment. Such adjustments may result in changes of mobility configurations, such as changes of RLM configurations or changes of mobility thresholds between the source and the target. In addition, target NG-RAN node, in the performed handover, may further optimize the dedicated RACH resources based on the measurements reported upon successful handovers.

In 3GPP Rel-18, a successful PSCell change report (e.g., it may be named as “a SPC-Report”, “a SPC-report”, “a SPC Report”, “a SPC report” or the like) would be introduced, to optimize PSCell change or CPAC related parameters, e.g., if a physical layer issue is detected by a UE during an ongoing legacy PSCell change procedure or an ongoing CPAC procedure. For reporting a SPC-Report, configurations for the UE to log or generate the SPC-Report (e.g., successPSCellChange-Config IE (information element)) is configured by a network, e.g., via an RRCReconfiguration message, including timer T304 related threshold (a threshold e.g., thresholdPercentageT304 generated by a target PSCell), timer T310 related threshold (a threshold e.g., thresholdPercentageT310 generated by a source PSCell or a source PCell), or timer T312 related threshold (a threshold e.g., thresholdPercentage T312 generated by a source PSCell or a source PCell). Based on the network configuration, the UE needs to log or generate successful PSCell change related parameters when at least one trigger condition is satisfied. A SPC-Report can be generated and reported to the network, including cell global identifier (CGI) information of the source PSCell, CGI information of the target PSCell, cause value for successful PSCell change report (e.g., t304-cause, t310-cause, or t312-cause), and measurement results.

In addition, a purpose of a SCG failure information procedure is to inform E-UTRAN or NR MN about a SCG failure the UE has experienced. A SCG failure type includes a SCG radio link failure, a failure of SCG reconfiguration with sync, a SCG configuration failure for an RRC message on signalling radio bearer (SRB) 3, a SCG integrity check failure, and a consistent uplink LBT failure on a PSCell for operation with shared spectrum channel access. A SCG failure type, measurement result(s) in MCG, and/or measurement result(s) in SCG can be included in a SCG failure information message. The following information can also be included in the SCG failure information message in case of a SCG failure: previous PSCell ID (i.e., PCI and ARFCN); failed PSCell ID (i.e., PCI and ARFCN); time SCG failure and/or RA-Information. After the network receives the SCG failure information message, it can trigger the UE to perform a SN release or modification or change procedure.

Currently, there is no MRO mechanism for a PCell change with a PSCell change procedure in a MR-DC scenario. In this application, a PCell change with PSCell change procedure may be a normal PCell change with normal PSCell change procedure, or a normal PCell change with conditional PSCell addition or change (CPAC) procedure, or a conditional PCell change with normal PSCell change procedure, or a conditional PCell change with CPAC procedure. Considering a near-failure successful case in a PCell change with PSCell change procedure (e.g., detecting underlying problems during successful PCell change with PSCell change), issues of how to support MRO functionality need to be addressed, for example: (1) how does a network configure for storing or reporting successful cell change related information for the near-failure successful PCell change with PSCell change procedure; and (2) how does a UE stores or reports successful cell change related information for the near-failure successful PCell change with PSCell change procedure.

Embodiments of the present application aim to resolve the abovementioned issues. Some embodiments of the present application reuse the procedure of SHR reporting and SPC-Report reporting for a near-failure successful PCell change with PSCell change procedure. More specifically, in an embodiment, a source MN (i.e., S-MN) configures SPC-Report trigger condition. In a further embodiment, a target MN (i.e., T-MN) configures SPC-Report trigger condition, and a trigger threshold is included in the HO Request ACK message. In another embodiment, a source SN (i.e., S-SN) configures SPC-Report trigger condition. Regarding a UE's behavior, in an embodiment, the UE immediately sends a SHR if triggered to T-MN, no matter whether a SPC-Report is triggered or whether PSCell change is successful. In a further embodiment, if a SHR is triggered first, the UE further checks whether the SPC-Report is triggered. In another embodiment, if the SPC-Report is triggered first, the UE further checks whether a SHR is triggered.

Some other embodiments of the present application introduce a new procedure for storing or reporting successful PCell change with PSCell change related information. To configure trigger condition, configuration for storing or reporting successful PCell change with PSCell change related information may consist of one set of trigger condition(s) associated with MCG and another set of trigger condition(s) associated with SCG. More specifically, in an embodiment, S-MN configures trigger condition(s) associated with SCG for triggering a successful PCell change with PSCell change report. In a further embodiment, T-MN configures trigger condition(s) associated with SCG for triggering a successful PCell change with PSCell change report, and a trigger threshold is included in the HO Request ACK message. In another embodiment, S-SN configures trigger condition(s) associated with SCG for triggering a successful PCell change with PSCell change report. Regarding a UE's behavior, in an embodiment, when at least one condition within the set of trigger condition(s) associated with MCG for triggering a successful PCell change with PSCell change report and at least one condition within the set of trigger condition(s) associated with SCG for triggering a successful PCell change with PSCell change report are fulfilled, the UE may generate or store successful PCell change with PSCell change related information (e.g., information associated with source SpCell, information associated with target SpCell). In a further embodiment, the UE only sends the stored information (e.g., a successful PCell change with PSCell change report) to the network (e.g., T-MN) when the PCell change with PSCell change procedure is successful. And, the successful PCell change with PSCell change report may be transferred to T-SN and/or S-MN and/or S-SN.

More details regarding the embodiments of the present application will be illustrated in the following text in combination with the appended drawings.

In general, to configure a SHR for a near-failure successful PCell change with PSCell change procedure, a trigger condition associated with the MCG e.g. T304 (associated with target PCell) related trigger condition for SHR (e.g., thresholdPercentageT304) is generated by T-MN. And, a trigger condition associated with the MCG e.g. T310 (associated with source PCell) related trigger condition for SHR (e.g., thresholdPercentageT310), or T312 (associated with the measurement identity of the target PCell) related trigger condition for SHR (e.g., thresholdPercentageT312) is generated by S-MN.

To configure a SPC-Report for a near-failure successful PCell change with PSCell change procedure, a trigger condition associated with the SCG e.g. T304 (associated with target PSCell) related trigger condition for SPC-Report is generated by T-SN, i.e., T304 related threshold for triggering SPC-Report is included in “SN Addition Request ACK message” or “SgNB release request ACK message” and “Handover Request ACK message”. Then, S-MN may send T304 related threshold for triggering SPC-Report to the UE via a RRC message.

In legacy, for a pure SPC-Report in a MN initiated PSCell change procedure, a MN configures T310 (associated with source PSCell) and/or T312 (associated with the measurement identity of the target PSCell) related threshold for triggering SPC-Report. In a SN initiated PSCell change procedure, S-SN configures T310 (associated with source PSCell) and/or T312 (associated with the measurement identity of the target PSCell) related threshold for triggering SPC-Report.

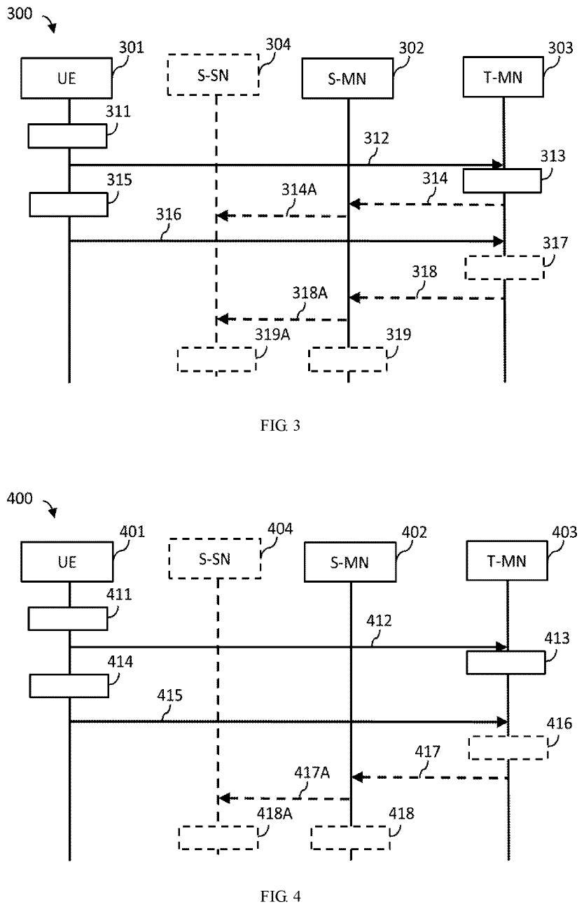

Differently, in some embodiments of the present application (denoted as Embodiment 1-1 for simplicity), when considering MRO for near-failure successful PCell change with PSCell change procedure, the mechanism of SHR reporting nd mechanism of SPC reporting are reused. A UE's reporting behaviors are illustrated in embodiments of FIGS. 2-5 as below.

In some embodiments of the present application, the SHR and the SPC report are two separate reports. In an embodiment, the SHR includes successful PCell change related information, and the SPC report includes successful PSCell change related information. In some other embodiments of the present application, the SHR includes the SPC report, i.e., the SPC report is a part of the SHR. In an embodiment, the SHR includes both successful PCell change related information and successful PSCell change related information.

In some embodiments of the present application, in the case that the SHR and the SPC report are two separate reports, configuration(s) for the SHR are only configuration(s) for the SHR which includes successful PCell change related information, or configuration(s) for the SHR include the configuration for a set of trigger conditions associated with a master cell group (MCG), i.e., only used for storing or reporting successful PCell change related information. In some other embodiments of the present application, in the case that the SHR includes the SPC report, configuration(s) for the SHR are configuration(s) used for storing or reporting both successful PCell change related information and successful PSCell change related information, which means that configuration(s) for the SHR include the configuration for a set of trigger conditions associated with a master cell group (MCG) and the configuration for a set of trigger conditions associated with a secondary cell group (SCG).

Embodiment 1-1 reuse and combine a SHR and a SPC-Report to configure trigger condition(s) for near-failure successful PCell change with PSCell change procedure. To configure a SPC-Report in a near-failure successful PCell change with PSCell change procedure, Embodiment 1-1 may use following solutions (i.e., Solution 1, Solution 2, and Solution 3), to configure the set of trigger conditions associated with the SCG, for example, to configure T310 (associated with source PSCell) and/or T312 (associated with the measurement identity of the target PSCell) related threshold for triggering SPC-Report. In Embodiment 1-1 (e.g., Solution 1, Solution 2, and Solution 3), “the set of trigger conditions associated with the SCG” or “threshold (condition) for SPC-Report or triggering SPC-Report” means the configured parameters are used for storing or reporting successful PSCell change related information; “the set of trigger conditions associated with the MCG” or “threshold (condition) for SHR or triggering SHR” means the configured parameters are used for storing or reporting successful PCell change related information. The SPC-Report may be a separate report different with a SHR, or one part of a SHR.

### Solution 1

If it is S-MN to configure the set of trigger conditions associated with the SCG, for example, to configure T310/T312 related threshold for triggering SPC-Report, currently, S-MN does not know whether T-MN performs PSCell change in a PCell change with PSCell change procedure since it is T-MN to decide whether or how to change PSCell (e.g., whether to trigger a legacy PSCell change or CPAC procedure). If it is S-MN to configure T310/T312 related threshold for triggering SPC-Report, S-MN needs to know T-MN triggers PSCell change, or S-MN needs to be informed by T-MN to configure T310/T312 related threshold for triggering SPC-Report. In an embodiment of Solution 1, an indication may be included in the HO Request ACK message (in or out of the Transparent Container for HO/PCell change) to indicate that T310 or T312 related threshold for triggering SPC-Report needs to be configured.

In Solution 1, besides T310 or T312 related threshold for triggering SPC-Report, since S-MN also configures the set of trigger conditions associated with the MCG, for example, S-MN also configures T310/T312 related threshold for triggering SHR, there may be following solutions, i.e., Solution 1-1 and Solution 1-2.

Solution 1-1: one common T310 related threshold can be configured for both a SHR and a SPC-Report, and/or, one common T312 related threshold can be configured for both the SHR and the SPC-Report. For example, “20%”, “40%”, “60%” or “80%” can be configured as the common T310 related threshold; “20%”, “40%”, “60%”or “80%”can be configured as the common T312 related threshold.

In some embodiments of Solution 1-1, only one common trigger threshold, e.g., “40%” (i.e., a value of the common thresholdPercentageT310 associated with both source PCell and source PSCell), can be included in a RRC message to be sent to the UE (the value of the common thresholdPercentageT310 is configured by the source MN before executing the last reconfiguration with sync/PCell change with PSCell change procedure). For example, an explicit or implicit indication is also needed to be included in the RRC message to let the UE know that the trigger threshold is configured for both the SHR and the SPC-Report, i.e., an explicit or implicit indication for indicating that the one common trigger threshold is configured for both the set of trigger conditions associated with the MCG (which are used to trigger SHR) and the set of trigger conditions associated with the SCG (which are used to trigger SPC-Report). In this way, the UE may store related information or generate related variable separately when corresponding trigger condition is fulfilled.

In these embodiments of Solution 1-1, if only threshold condition for triggering SPC-Report is fulfilled, the UE only stores or generates a SPC-Report for the PCell change with PSCell change procedure, i.e., the UE only stores or generates successful PSCell change related information. If only threshold condition for triggering a SHR is fulfilled, the UE only stores or generates the SHR for the PCell change with PSCell change procedure, i.e., the UE only stores or generates successful PCell change related information. If both threshold condition for triggering SHR and threshold condition for triggering SPC-Report are fulfilled, the UE stores or generates the SHR and the SPC-Report for the PCell change with PSCell change procedure, i.e., the UE stores or generates successful PCell change related information and successful PSCell change related information. In Solution 1-1, the stored or generated SHR and the stored or generated SPC report may be two separate reports, or the stored or generated SPC report may be encapsulated in the stored or generated SHR.

In particular, in an embodiment, when one common trigger threshold, e.g., “40%” (i.e., a value of the common thresholdPercentageT310 associated with both source PCell and source PSCell) is sent to the UE, the UE may store successful PCell change related information, or the UE may generate VarSuccessHO-Report, when “the ratio between the value of the elapsed time of the timer T310 of source PCell and the configured value of the timer T310 configured for source PCell while the UE was connected to the source PCell before executing the last PCell change with PSCell change procedure”is greater than, e.g., “40%”.

In a further embodiment, when one common trigger threshold, e.g., “40%” (i.e., a value of the common thresholdPercentageT310 associated with both source PCell and source PSCell) is sent to the UE, the UE may store successful PSCell change related information, or the UE may generate VarSPC-Report, when “the ratio between the value of the elapsed time of the timer T310 of source PSCell and the configured value of the timer T310 configured for source PSCell while the UE was connected to the source PSCell before executing the last PCell change with PSCell change procedure”is greater than, e.g., “40%”.

In some other embodiments of Solution 1-1, even the value of T310 related threshold for SHR and SPC-Report is the same, or even the value of T312 related threshold for SHR and SPC-Report is the same, two separate trigger thresholds having different IE names can be configured. For example, one threshold “40%” configured as T310 related threshold for SHR (e.g., thresholdPercentageT310forSHR or thresholdPercentageT310ofPCell) as well as another threshold “40%” configured as T310 related threshold for SPC-Report (e.g., thresholdPercentageT310forSPC or thresholdPercentageT310ofPSCell) can be included in the RRC message to be sent to the UE, i.e., an implicit indication for indicating that the two trigger thresholds are configured for the set of trigger conditions associated with the MCG (which are used to trigger SHR) and the set of trigger conditions associated with the SCG (which are used to trigger SPC-Report) separately. In this way, the UE can understand the thresholds for triggering SHR and SPC-Report based on the different IE names.

In these embodiments of Solution 1-1, if only threshold condition for triggering SPC-Report is fulfilled, the UE only stores or generates SPC-Report for the PCell change with PSCell change procedure, i.e., the UE only stores or generates successful PSCell change related information. If only threshold condition for triggering SHR is fulfilled, the UE only stores or generates SHR for the PCell change with PSCell change procedure, i.e., the UE only stores or generates successful PCell change related information. If both threshold condition for triggering SHR and threshold condition for triggering SPC-Report are fulfilled, the UE stores or generates the SHR and the SPC-Report for the PCell change with PSCell change procedure, i.e., the UE stores or generates successful PCell change related information and successful PSCell change related information. In Solution 1-1, the stored or generated SHR and the stored or generated SPC report may be two separate reports, or the stored or generated SPC report may be encapsulated in the stored or generated SHR.

In particular, in an embodiment, when one threshold “40%” configured as T310 related threshold for SHR (e.g., thresholdPercentageT310forSHR or thresholdPercentageT310ofPCell) is sent to the UE, the UE may store successful PCell change related information or the UE may generate VarSuccessHO-Report, when “the ratio between the value of the elapsed time of the timer T310 of source PCell and the configured value of the timer T310 configured for source PCell while the UE was connected to the source PCell before executing the last PCell change with PSCell change procedure” is greater than “40%”. For example, the value of thresholdPercentageT310forSHR or thresholdPercentageT310ofPCell is configured by S-MN before executing the last reconfiguration with sync/PCell change with PSCell change procedure.

In a further embodiment, when another threshold “40%” configured as T310 related threshold for SPC-Report (e.g., thresholdPercentageT310forSPC-Report or thresholdPercentageT310ofPSCell) is sent to the UE, the UE may store successful PSCell change related information, or the UE may generate VarSPC-Report, when “the ratio between the value of the elapsed time of the timer T310 of source PSCell and the configured value of the timer T310 configured for source PSCell while the UE was connected to the source PSCell before executing the last PCell change with PSCell change procedure” is greater than, e.g., “40%”. For example, the value of thresholdPercentageT310forSPC-Report or thresholdPercentageT310ofPSCell is configured by S-MN before executing the last reconfiguration with sync/PCell change with PSCell change procedure.

Solution 1-2: different T310 related threshold can be configured for a SHR and a SPC-Report separately, and/or different T312 related threshold can be configured for the SHR and the SPC-Report separately. To enable the UE to understand the separate thresholds for triggering SHR and SPC-Report, different IE names can be defined for trigger threshold for SHR and SPC-Report. For example, “60%” configured as T310 related threshold for SHR (e.g., defined as thresholdPercentageT310forSHR or thresholdPercentageT310ofPCell), as well as “40%” configured as T310 related threshold for SPC-Report (e.g., defined as thresholdPercentageT310forSPC-Report or thresholdPercentage T310ofPSCell) can be included in the RRC message to be sent to the UE, i.e., an implicit indication for indicating that the two trigger thresholds are configured for the set of trigger conditions associated with the MCG (which are used to trigger SHR) and the set of trigger conditions associated with the SCG (which are used to trigger SPC-Report) separately. In this way, the UE may store or generate report correspondingly.

In Solution 1-2, if only threshold condition for triggering SPC-Report is fulfilled, the UE only stores or generates a SPC-Report for the PCell change with PSCell change procedure, i.e., the UE only stores or generates successful PSCell change related information. If only threshold condition for triggering SHR is fulfilled, the UE only stores or generates SHR for the PCell change with PSCell change procedure, i.e., the UE only stores or generates successful PCell change related information. If both threshold condition for triggering SHR and threshold condition for triggering SPC-Report are fulfilled, the UE stores or generates SHR and SPC-Report for the PCell change with PSCell change procedure, i.e., the UE stores or generates successful PCell change related information and successful PSCell change related information. In Solution 1-2, the stored or generated SHR and the stored or generated SPC report may be two separate reports, or the stored or generated SPC report may be encapsulated in the stored or generated SHR.

In particular, in some embodiments of Solution 1-2, when one threshold “60%” configured as T310 related threshold for SHR (e.g., thresholdPercentageT310forSHR or thresholdPercentageT310ofPCell) is sent to the UE, the UE may store successful PCell change related information or the UE may generate VarSuccessHO-Report, when “the ratio between the value of the elapsed time of the timer T310 of source PCell and the configured value of the timer T310 configured for source PCell while the UE was connected to the source PCell before executing the last PCell change with PSCell change procedure” is greater than, e.g., “60%”. For example, the value of thresholdPercentageT310forSHR or thresholdPercentageT310ofPCell is configured by the source MN before executing the last reconfiguration with sync/PCell change with PSCell change procedure.

In Some Other Embodiments of Solution 1-2, When Another Threshold “40%”configured as T310 related threshold for SPC-Report (e.g., thresholdPercentageT310forSPC-Report or thresholdPercentageT310ofPSCell) is sent to the UE, the UE may store successful PSCell change related information or the UE may generate VarSPC-Report, when the ratio between the value of the elapsed time of the timer T310 of source PSCell and the configured value of the timer T310 configured for source PSCell while the UE was connected to the source PSCell before executing the last PCell change with PSCell change procedure, is greater than, e.g., “40%”. For example, the value of thresholdPercentageT310forSPC-Report or thresholdPercentageT310ofPSCell is configured by the source MN before executing the last reconfiguration with sync/PCell change with PSCell change procedure.

### Solution 2

If it is T-MN to configure the set of trigger conditions associated with the SCG, for example, to configure T310/T312 related threshold for triggering SPC-Report, T-MN sends the set of trigger conditions associated with the SCG to S-MN, e.g., T310/T312 related threshold for triggering SPC-Report is included in the HO Request ACK message (within or out of the Transparent Container for HO/PCell change). Then, S-MN may send T310/T312 related threshold for triggering SPC-Report to the UE via a RRC message. The UE may store related information or generate success report correspondingly based on the fulfilled trigger condition.

In some embodiments of Solution 2, if only threshold condition for triggering SPC-Report is fulfilled, the UE only stores or generates a SPC-Report for the PCell change with PSCell change procedure, i.e., the UE only stores or generates successful PSCell change related information. If only threshold condition for triggering SHR is fulfilled, the UE only stores or generates SHR for the PCell change with PSCell change procedure, i.e., the UE only stores or generates successful PCell change related information. In some other embodiments of Solution 2, if both threshold condition for triggering SHR and threshold condition for triggering SPC-Report are fulfilled, the UE stores or generates a SHR and a SPC-Report for the PCell change with PSCell change procedure, i.e., the UE stores or generates successful PCell change related information and successful PSCell change related information. In Solution 2, the stored or generated SHR and the stored or generated SPC report may be two separate reports, or the stored or generated SPC report may be encapsulated in the stored or generated SHR.

### Solution 3

If it is S-SN to configure the set of trigger conditions associated with the SCG, for example, to configure T310/T312 related threshold for triggering SPC-Report, T-MN needs to indicate that T310/T312 related threshold for triggering SPC-Report needs to be configured. For example, T-MN indicates S-MN that T310/T312 related threshold for triggering SPC-Report needs to be configured, and then, S-MN indicates S-SN that T310/T312 related threshold for triggering SPC-Report needs to be configured. In some embodiments of Solution 3, an indication may be included in the HO Request ACK message (out of the Transparent Container for HO/PCell change), to indicate S-MN to configure T310/T312 related threshold for triggering SPC-Report. In a further embodiment, an indication may be included in the SN Release Request message or the SgNB Release Request message to indicate S-SN to configure T310/T312 related threshold for triggering SPC-Report. In some other embodiments of Solution 3, T310/T312 related threshold for triggering SPC-Report can be included in the SN Release Request ACK message or the SgNB Release Request ACK message. Then, S-MN may send T310/T312 related threshold for triggering SPC-Report to the UE via a RRC message. The UE may store related information or generate success report correspondingly based on the fulfilled trigger condition.

In Solution 3, for instance, if only threshold condition for triggering SPC-Report is fulfilled, the UE only stores or generates a SPC-Report for the PCell change with PSCell change procedure, i.e., the UE only stores or generates successful PSCell change related information. If only threshold condition for triggering SHR is fulfilled, the UE only stores or generates SHR for the PCell change with PSCell change procedure, i.e., the UE only stores or generates successful PCell change related information. If both threshold condition for triggering SHR and threshold condition for triggering SPC-Report are fulfilled, the UE stores or generates a SHR and a SPC-Report for the PCell change with PSCell change procedure, i.e., the UE stores or generates successful PCell change related information and successful PSCell change related information. In Solution 3, the stored or generated SHR and the stored or generated SPC report may be two separate reports, or the stored or generated SPC report may be encapsulated in the stored or generated SHR.

On basis of Embodiment 1-1, after a UE receives configurations for storing or reporting a SHR and/or a SPC-Report, the UE's behaviours are described in following embodiments of the present application, i.e., Embodiment 1-2-1, Embodiment 1-2-2, and Embodiment 1-2-3. In Embodiment 1-2-1, Embodiment 1-2-2, and Embodiment 1-2-3, “trigger condition(s) for (a) SHR” means a set of trigger conditions associated with a MCG, “trigger condition(s) for (a) SPC-Report” means a set of trigger conditions associated with a SCG.

### Embodiment 1-2-1

When trigger condition(s) for a SHR is met, upon a UE successfully access to the target PCell (i.e., T304 for target PCell is stopped), the UE may immediately send the SHR (e.g., including successful PCell change related information) to T-MN, no matter whether a SPC-Report is triggered or whether PSCell change is successful, T-MN may transfer the SHR to S-MN (e.g., when the SHR is triggered due to source MN configured trigger condition(s) is met). Then, for instance, S-MN may transfer the SHR to S-SN. In Embodiment 1-2-1, SHR and SPC-Report may be two separate reports, or SPC report is a part of SHR or is encapsulated in SHR. In Embodiment 1-2-1, after the SHR is sent, there may be following different four cases, i.e., Case 1, Case 2, Case 3, and Case 4.
(1) Case 1: trigger condition(s) for SPC-Report is met, and the UE successfully access to the target PSCell. The UE may also send the SPC-Report (e.g., including successful PSCell change related information) to T-MN, T-MN may transfer the SPC-Report to S-MN (e.g., when the SPC-Report is triggered due to source MN configured trigger condition(s) is met), S-MN may transfer the SPC-Report to S-SN (e.g., when the SPC-Report is triggered due to source SN configured trigger condition(s) is met). Specific examples of Case 1 are described in the embodiments of FIGS. 2-5 as follows.
(2) Case 2: trigger condition(s) for SPC-Report is not met, and the UE successfully access to the target PCell. In this case, no SPC-Report is generated or triggered.
(3) Case 3: trigger condition(s) for SPC-Report is met, but the UE fails to access to the target PSCell. The UE may send the SCG failure information message to T-MN, and T-MN may transfer the SCG failure information to S-MN. Then, for instance, S-MN may transfer the SCG failure related information to S-SN.
(4) Case 4: trigger condition(s) for SPC-Report is not met, and the UE fails to access to the target PSCell. The UE may send the SCG failure information message to T-MN, T-MN may transfer the SCG failure information to S-MN. Then, for instance, S-MN may transfer the SCG failure related information to source SN. Specific examples of Cases 3 and 4 are described in the embodiments of FIGS. 2-5 as follows.

FIG. 2 illustrates an exemplary flowchart of transmitting SHR in accordance with some embodiments of the present application. Details described in all other embodiments of the present application are applicable for the embodiments shown in FIG. 2. It should be appreciated by persons skilled in the art that the sequence of the operations in exemplary procedure 200 in FIG. 2 may be changed and some of the operations in exemplary procedure 200 in FIG. 2 may be eliminated or modified, without departing from the spirit and scope of the disclosure.

Specifically, the exemplary flowchart 200 may refer to Case 1, Case 3, or Case 4 in different embodiments of FIG. 2.

In Case 1, in the exemplary flowchart 200 as shown in FIG. 2, in operation 211, UE 201 may successfully complete a RA procedure to T-MN 203. In operation 212, UE 201 may transmit a SHR to T-MN 203.

Optionally, in operation 213, T-MN 203 may transfer the received SHR to S-MN 202. In operation 213A, S-MN 202 may further transfer the received SHR to S-SN 204.

In operation 214, UE 201 may successfully complete a RA procedure to T-SN (not shown in FIG. 2). In operation 215, UE 201 may transmit a SPC-Report to T-MN 203.

Optionally, in operation 216, T-MN 203 may determine whether the SHR and the SPC-Report are related to the same PCell change with PSCell change procedure.

Optionally, in operation 217, T-MN 203 may transfer the SPC-Report to S-MN 202, and details are described in Options 1-3 of Case 1 as below. In operation 218, S-MN 202 may determine whether the SHR and the SPC-Report are related to the same PCell change with PSCell change procedure.

Optionally, in operation 217A, S-MN 202 may further transfer the SPC-Report to S-SN 204. In operation 218A, S-SN 204 may determine whether the SHR and the SPC-Report are related to the same PCell change with PSCell change procedure.

In Case 1, a network node (e.g., T-MN and/or S-MN and/or S-SN) may first receive a SHR and then receive a SPC-Report, since the SHR and the SPC-Report are for the same PCell change with PSCell change procedure, the network node needs to correlate them when performing MRO analysis. To solve the issue about how to correlate the SHR with the SPC-Report for MRO, there may be following options in different embodiments of FIG. 2 in Case 1, i.e., Options 1-3 as below.
Option 1: C-RNTI of target PCell and/or C-RNTI of source PCell may be included in the SHR which is transmitted or transferred in operations 212, 213, and 213A, also, C-RNTI of target PCell and/or C-RNTI of source PCell may be included in the SPC-Report which is transmitted or transferred in operations 215, 217 and 217A. After the network node (e.g., T-MN 203 and/or S-MN 202 and/or S-SN 204) receives the SHR and the SPC-Report, based on the same C-RNTI, the network node (e.g., T-MN 203 and/or S-MN 202 and/or S-SN 204) can correlate the SHR and the SPC-Report, i.e., can determine that the SHR and the SPC-Report are related to the same PCell change with PSCell change procedure.
Option 2: UE 201 can include an indication in the SPC-Report in operation 215, to indicate that the latest SHR if any (e.g., in operation 212) is associated with the same PCell change with PSCell change procedure. For example, the indication in the SPC-Report in operation 215 may also be transmitted to S-MN 202, when T-MN 203 transfers the SPC-Report to S-MN 202 in operation 217 if needed. The indication may also be transmitted to S-SN 204, when S-MN 202 transfers the SPC-Report to S-SN 204 in operation 217A if needed. After the network node (e.g., T-MN 203 and/or S-MN 202 and/or S-SN 204) receives the SHR and the SPC-Report, based on the indication, the network node (e.g., T-MN 203 and/or S-MN 202 and/or S-SN 204) can correlate the SHR and the SPC-Report, i.e., can determine that the SHR and the SPC-Report are related to the same PCell change with PSCell change procedure.
Option 3: UE 201 can include time information in the SHR in operation 212, i.e., absolute timestamp when SHR is generated or transmitted, or time elapsed from receiving RRC message for PCell change with PSCell change to SHR is generated or transmitted. The UE can include time information in the SPC-Report in operation 215, i.e., absolute timestamp when SPC-Report is generated or transmitted, or time elapsed from receiving RRC message for PCell change with PSCell change to SPC-Report is generated or transmitted, or time elapsed from SHR is generated or transmitted to SPC-Report is generated or transmitted. The time information in the SHR may be transmitted to S-MN 202, when T-MN 203 transfers the SHR to S-MN 202 in operation 213 if needed, and the time information may also be transmitted to S-SN 204, when S-MN 202 transfers the SHR to S-SN 204 in operation 213A if needed. The time information in the SPC-Report may be transmitted to S-MN 202, when T-MN 203 transfers the SPC-Report to S-MN 202 in operation 217 if needed, and the time information may also be transmitted to S-SN 204, when S-MN 202 transfers the SPC-Report to S-SN 204 in operation 217A if needed.

In Option 3, after the network node (e.g., T-MN 203 and/or S-MN 202 and/or S-SN 204) receives the SHR and the SPC-Report, based on the included time information, the network node (e.g., T-MN 203 and/or S-MN 202 and/or S-SN 204) can understand that the SHR and the SPC-Report are for the same PCell change with PSCell change procedure (e.g., the time elapsed between these two reports are smaller than a configured threshold).

In Case 3 and Case 4, in the exemplary flowchart 200 as shown in FIG. 2, in operation 211, UE 201 may successfully complete a RA procedure to T-MN 203. In operation 212, UE 201 may transmit a SHR to T-MN 203. Optionally, in operation 213, T-MN 203 may transfer the received SHR to S-MN 202. In operation 213A, S-MN 202 may further transfer the received SHR to S-SN 204.

In operation 214, a RA procedure performed by UE 201 to T-SN (not shown in FIG. 2) may be failed or a RLF happened in T-SN. In operation 215, UE 201 may transmit SCG failure related information, e.g., which is included in a SCG failure information message, to T-MN 203.

Optionally, in operation 216, T-MN 203 may determine whether the SHR and the SCG failure related information are related to the same PCell change with PSCell change procedure.

Optionally, in operation 217, T-MN 203 may transfer the SCG failure related information to S-MN 202, and details are described in Options a-c of Case 3 and Case 4 as below. In operation 218, S-MN 202 may determine whether the SHR and the SCG failure related information are related to the same PCell change with PSCell change procedure.

Optionally, in operation 217A, S-MN 202 may further transfer the SCG failure related information to S-SN 204. In operation 218A, S-SN 204 may determine whether the SHR and the SCG failure related information are related to the same PCell change with PSCell change procedure.

In Case 3 and Case 4, a network node (e.g., T-MN 203 and/or S-MN 202 and/or S-SN) may firstly receive the SHR and secondly receive the SCG failure information message. Since the SHR and the SCG failure information message are for the same PCell change with PSCell change procedure, the network node needs to correlate them when performing MRO analysis. To solve the issue about how to identify whether SuccessHO-Report and SCG failure related information are associated with the same PCell change with PSCell change procedure for MRO analysis in Case 3 and Case 4, there may be following options in different embodiments of FIG. 2 in Case 3 and Case 4, i.e., Options a-c as below.
Option a: C-RNTI of target PCell and/or C-RNTI of source PCell may be included in the SCG failure information message in operations 215, 217, and 217A. After the network node (e.g., T-MN 203 and/or S-MN 202 and/or S-SN 204) receives the SHR and SCG failure related information, based on the same C-RNTI, the network node (e.g., T-MN 203 and/or S-MN 202 and/or S-SN 204) can correlate the SHR and the SCG failure information, i.e., can determine that the SHR and the SCG failure information are related to the same PCell change with PSCell change procedure.
Option b: UE 201 can include an indication in the SCG failure information message in operation 215, to indicate that the latest SHR if any (e.g., in operation 212) is associated with the same PCell change with PSCell change procedure. For example, the indication may also be transmitted to S-MN 202, when T-MN 203 transfers the SCG failure related information to S-MN 202 if needed. The indication may also be transmitted to S-SN 204, when S-MN 202 transfers the SPC-Report to S-SN 204 in operation 217A if needed. After the network node (e.g., T-MN 203 and/or S-MN 202 and/or S-SN 204) receives the SHR and the SCG failure related information, based on the indication, the network node (e.g., T-MN 203 and/or S-MN 202 and/or S-SN 204) can correlate the SHR and the SCG failure related information, i.e., can determine that the SHR and the SCG failure related information are related to the same PCell change with PSCell change procedure.
Option c: UE 201 can include time information in the SHR in operation 212, i.e., absolute timestamp when the SHR is generated or transmitted, or time elapsed from “the time when an RRC message for PCell change with PSCell change is received” to “the time when the SHR is generated or transmitted”. UE 201 can include time information in the SCG failure information message, i.e., absolute timestamp when SCG failure information message is generated or transmitted, or time elapsed from “the time when an RRC message for PCell change with PSCell change is received” to “the time when the SCG failure information message is generated or transmitted”, or time elapsed from “the time when the SHR is generated or transmitted” to “the time when the SCG failure information is generated or transmitted”. The time information in the SHR may be transmitted to S-MN 202, when T-MN 203 transfers the SHR to S-MN 202 in operation 213 if needed, and the time information may also be transmitted to S-SN 204, when S-MN 202 transfers the SHR to S-SN 204 in operation 213A if needed. The time information in the SCG failure related information may be transmitted to S-MN 202, when T-MN 203 transfers the SCG failure related information to S-MN 202 in operation 217 if needed, and the time information may also be transmitted to S-SN 204, when S-MN 202 transfers the SCG failure related information to S-SN 204 in operation 217A if needed.

In Option c, after the network node (e.g., T-MN 203 and/or S-MN 202 and/or S-SN 204) receives the SHR and the SCG failure related information, based on the include time information, the network node (e.g., T-MN 203 and/or S-MN 202 and/or S-SN 204) can understand that the SHR and the SCG failure related information are for the same PCell change with PSCell change procedure (e.g., the time elapsed between these two reports are smaller than a configured threshold).

FIG. 3 illustrates a further exemplary flowchart of transmitting SHR in accordance with some embodiments of the present application. Details described in all other embodiments of the present application are applicable for the embodiments shown in FIG. 3. It should be appreciated by persons skilled in the art that the sequence of the operations in exemplary procedure 300 in FIG. 3 may be changed and some of the operations in exemplary procedure 300 in FIG. 3 may be eliminated or modified, without departing from the spirit and scope of the disclosure.

Specifically, the exemplary flowchart 300 may refer to Case 1, Case 3, or Case 4 in different embodiments of FIG. 3.

In Case 1, in the exemplary flowchart 300 as shown in FIG. 3, in operation 311, UE 301 may successfully complete a RA procedure to T-MN 303. In operation 312, UE 301 may transmit a SHR to T-MN 303. In operation 313, T-MN303 may start a timer upon receiving the SHR (e.g., timer duration may equal to Tstore_UE_cntxt).

Optionally, in operation 314, T-MN 303 may transfer the received SHR to S-MN 302. In operation 314A, S-MN 302 may further transfer the received SHR to S-SN 304.

In operation 315, UE 301 may successfully complete a RA procedure to T-SN (not shown in FIG. 3). In operation 316, UE 301 may transmit a SPC-Report to T-MN 303.

Optionally, in operation 317, T-MN 303 may determine whether the SHR and the SPC-Report are related to the same PCell change with PSCell change procedure.

Optionally, in operation 318, T-MN 303 may transfer the SPC-Report to S-MN 302, and details are described in Option 4 of Case 1 as below. In operation 319, S-MN 302 may determine whether the SHR and the SPC-Report are related to the same PCell change with PSCell change procedure.

Optionally, in operation 318A, S-MN 302 may further transfer the SPC-Report to S-SN 304. In operation 319A, S-SN 304 may determine whether the SHR and the SPC-Report are related to the same PCell change with PSCell change procedure.

In Case 1, to solve the issue about how to correlate the SHR with the SPC-Report for MRO, there may be Option 4 as below.
Option 4: After T-MN 303 receives SHR in operation 312, T-MN 303 can start a timer (e.g., timer duration may equal to Tstore_UE_cntxt) in operation 313. If the SPC-Report is received before the timer is expired, T-MN 303 can understand that the SHR and the SPC-Report are for the same PCell change with PSCell change procedure. In Option 4, an indication may also be transmitted to S-MN 302 by T-MN 303 when T-MN 303 transfers the SPC-Report to S-MN 302 in operation 318 if needed, to indicate that the latest SHR and the SPC-Report are associated with the same PCell change with PSCell change procedure. Such indication may also be transmitted to S-SN 304 by S-MN 302 when S-MN 302 transfers the SPC-Report to S-SN 304 in operation 318A if needed. Based on this indication, S-MN 302 and/or S-SN 304 can correlate the SHR and the SPC-Report, i.e., can determine that the SHR and the SPC-Report are related to the same PCell change with PSCell change procedure.

In Case 3 and Case 4, in the exemplary flowchart 300 as shown in FIG. 3, in operation 311, UE 301 may successfully complete a RA procedure to T-MN 303. In operation 312, UE 301 may transmit a SHR to T-MN 303. In operation 313, T-MN 303 may start a timer upon receiving the SHR (e.g., timer duration may equal to Tstore_UE_cntxt). Optionally, in operation 314, T-MN 303 may transfer the received SHR to S-MN 302. In operation 314A, S-MN 302 may further transfer the received SHR to S-SN 304.

In operation 315, a RA procedure performed by UE 301 to T-SN (not shown in FIG. 3) may be failed or a RLF happened in T-SN. In operation 316, UE 301 may transmit SCG failure related information, e.g., which is included in a SCG failure information message, to T-MN 303. Optionally, in operation 317, T-MN 303 may determine whether the SHR and the SCG failure related information are related to the same PCell change with PSCell change procedure.

Optionally, in operation 318, T-MN 303 may transfer the SCG failure related information to S-MN 302, and details are described in Option d of Case 3 and Case 4 as below. In operation 319, S-MN 302 may determine whether the SHR and the SCG failure related information are related to the same PCell change with PSCell change procedure.

Optionally, in operation 318A, S-MN 302 may further transfer the SCG failure related information to S-SN 304. In operation 319A, S-SN 304 may determine whether the SHR and the SCG failure related information are related to the same PCell change with PSCell change procedure.

In Case 3 and Case 4, to solve the issue about how to identify whether SuccessHO-Report and SCG failure related information are associated with the same PCell change with PSCell change procedure for MRO analysis, there may be Option d as below.
Option d: After T-MN 303 receives the SHR in operation 312, T-MN 303 starts a timer (e.g., timer duration may equal to Tstore_UE_cntxt). If the SCG failure information message is received before the timer is expired, T-MN 303 can understand that the SHR and the SCG failure information message are for the same PCell change with PSCell change procedure. In Option d, an indication which indicates that the latest SHR is associated to the same PCell change with PSCell change procedure may also be transmitted to S-MN 302 by T-MN 303, when T-MN 303 transfers the SCG failure related information to S-MN 302 in operation 318 if needed. Such indication may also be transmitted to S-SN 304 by S-MN 302, when S-MN 302 transfers the SCG failure related information to S-SN 304 in operation 318A if needed. Based on the indication, S-MN 302 and/or S-SN 304 can correlate the SHR and the SCG failure related information, i.e., can determine that the SHR and the SCG failure related information are related to the same PCell change with PSCell change procedure.

FIG. 4 illustrates another exemplary flowchart of transmitting SHR in accordance with some embodiments of the present application. Details described in all other embodiments of the present application are applicable for the embodiments shown in FIG. 4. It should be appreciated by persons skilled in the art that the sequence of the operations in exemplary procedure 400 in FIG. 4 may be changed and some of the operations in exemplary procedure 400 in FIG. 4 may be eliminated or modified, without departing from the spirit and scope of the disclosure.

Specifically, the exemplary flowchart 400 may refer to Case 1, Case 3, or Case 4 in different embodiments of FIG. 4.

In Case 1, in the exemplary flowchart 400 as shown in FIG. 4, in operation 411, UE 401 may successfully complete a RA procedure to T-MN 403. In operation 412, UE 401 may transmit a SHR to T-MN 403. In operation 413, T-MN 403 may start a timer upon receiving the SHR (e.g., timer duration may equal to Tstore UE_cntxt).

In operation 414, UE 401 may successfully complete a RA procedure to T-SN (not shown in FIG. 4). In operation 415, UE 301 may transmit a SPC-Report to T-MN 403.

Optionally, in operation 416, T-MN 403 may determine whether the SHR and the SPC-Report are related to the same PCell change with PSCell change procedure.

Optionally, in operation 417, T-MN 403 may transfer both the SHR and the SPC-Report to S-MN 402, and details are described in Option 5 of Case 1 as below. In operation 418, S-MN 402 may determine whether the SHR and the SPC-Report are related to the same PCell change with PSCell change procedure.

Optionally, in operation 417A, S-MN 402 may further transfer the SHR and the SPC-Report to S-SN 404. In operation 418A, S-SN 404 may determine whether the SHR and the SPC-Report are related to the same PCell change with PSCell change procedure.

In Case 1, to solve the issue about how to correlate the SHR with the SPC-Report for MRO, there may be Option 5 as below.
Option 5: After T-MN 403 receives SHR in operation 412, T-MN 403 can start a timer (e.g., timer duration may equal to Tstore_UE_cntxt), if the SPC-Report is received before the timer is expired, T-MN 403 can understand that the SHR and the SPC-Report are for the same PCell change with PSCell change procedure. T-MN 403 may transfer the SHR and the SPC-Report together to S-MN 402 in one Xn or X2 message if needed, e.g., in operation 417. Since the SHR and the SPC-Report are received in one message, S-MN 402 can correlate the SHR and the SPC-Report. Optionally, S-MN 402 may transfer the SHR and the SPC-Report together to S-SN 404 in one Xn message or X2 if needed. Since the SHR and the SPC-Report are received in one message, S-SN 404 can correlate the SHR and the SPC-Report.

In Case 3 and Case 4, in the exemplary flowchart 400 as shown in FIG. 4, in operation 411, UE 401 may successfully complete a RA procedure to T-MN 403. In operation 412, UE 401 may transmit a SHR to T-MN 403. In operation 413, T-MN 403 may start a timer upon receiving the SHR (e.g., timer duration may equal to Tstore_UE_cntxt).

In operation 414, a RA procedure performed by UE 401 to T-SN (not shown in FIG. 4) may be failed or a RLF happened in T-SN. In operation 415, UE 301 may transmit SCG failure related information, e.g., which is included in a SCG failure information message, to T-MN 403.

Optionally, in operation 416, T-MN 403 may determine whether the SHR and the SCG failure related information are related to the same PCell change with PSCell change procedure.

Optionally, in operation 417, T-MN 403 may transfer both the SHR and the SCG failure related information to S-MN 402, and details are described in Option e of Case 3 and Case 4 as below. In operation 418, S-MN 402 may determine whether the SHR and the SCG failure related information are related to the same PCell change with PSCell change procedure.

Optionally, in operation 417A, S-MN 402 may further transfer the SHR and the SCG failure related information to S-SN 404. In operation 418A, S-SN 404 may determine whether the SHR and the SCG failure related information are related to the same PCell change with PSCell change procedure.

In Case 3 and Case 4, to solve the issue about how to identify whether SuccessHO-Report (or SHR) and SCG failure related information are associated with the same PCell change with PSCell change procedure for MRO analysis, there may be Option e as below.
Option e: After T-MN 403 receives the SHR in operation 412, T-MN 403 starts a timer (e.g., timer duration may equal to Tstore_UE_cntxt). If the SCG failure information message is received before the timer is expired, T-MN 403 can understand that the SHR and the SCG failure information message are for the same PCell change with PSCell change procedure, i.e., can correlate the SHR and the SCG failure related information. In Option e, T-MN 403 may transfer the SHR and the SCG failure related information together to S-MN 402 in one Xn or X2 message if needed, e.g., in operation 417. Since the SHR and the SCG failure related information are received in one message, S-MN 402 can correlate the SHR and the SCG failure related information. Optionally, S-MN 402 may transfer the SHR and the SCG failure related information together to S-SN 404 in one Xn or X2 message if needed, e.g., in operation 417A. Since the SHR and the SCG failure related information are received in one message, S-SN 404 can correlate the SHR and the SCG failure related information.

FIG. 5 illustrates an additional exemplary flowchart of transmitting SHR in accordance with some embodiments of the present application. Details described in all other embodiments of the present application are applicable for the embodiments shown in FIG. 5. It should be appreciated by persons skilled in the art that the sequence of the operations in exemplary procedure 500 in FIG. 5 may be changed and some of the operations in exemplary procedure 500 in FIG. 5 may be eliminated or modified, without departing from the spirit and scope of the disclosure.

Specifically, the exemplary flowchart 500 may refer to Case 1, Case 3, or Case 4 in different embodiments of FIG. 5.

In Case 1, in the exemplary flowchart 500 as shown in FIG. 5, in operation 511, UE 501 may successfully complete a RA procedure to T-MN 503. In operation 512, UE 501 may transmit a SHR to T-MN 503. In operation 513, T-MN 503 may transfer the SHR to S-MN 502. In operation 514, S-MN 502 starts a timer (e.g., timer duration may equal to Tstore_UE_cntxt) upon receiving the SHR.

In operation 515, UE 501 may successfully complete a RA procedure to T-SN (not shown in FIG. 5). In operation 516, UE 501 may transmit a SPC-Report to T-MN 503. In operation 517, T-MN 503 may transfer the SPC-Report to S-MN 502. If the SPC-Report is received before the timer is expired, S-MN 502 can understand that the SHR and the SPC-Report are for the same PCell change with PSCell change procedure, i.e., in operation 518, S-MN 502 can correlate the SHR and the SPC-Report.

Optionally, in operation 513A, S-MN 502 may transfer the SHR to S-SN 504. In operation 514A, S-SN 504 may start a timer (e.g., timer duration may equal to Tstore_UE_cntxt) upon receiving the SHR. In operation 517A, S-MN 502 may transfer the SPC-Report to S-SN 504. In operation 518A, S-SN 504 may determine that the SHR and the SPC-Report are related to the same PCell change with PSCell change procedure, if the SPC-Report is received before the timer is expired, i.e., S-SN 504 can correlate the SHR and the SPC-Report.

In Case 3 and Case 4, in the exemplary flowchart 500 as shown in FIG. 5, in operation 511, UE 501 may successfully complete a RA procedure to T-MN 503. In operation 512, UE 501 may transmit a SHR to T-MN 503. In operation 513, T-MN 503 may transfer the SHR to S-MN 502. In operation 514, S-MN 502 starts a timer (e.g., timer duration may equal to Tstore_UE_cntxt) upon receiving the SHR, to solve the issue about how to identify whether SHR/SuccessHO-Report and SCG failure related information are associated with the same PCell change with PSCell change procedure for MRO analysis in Case 3 and Case 4.

In operation 515, a RA procedure performed by UE 501 to T-SN (not shown in FIG. 5) may be failed or a RLF happened in T-SN. In operation 516, UE 501 may transmit SCG failure related information, e.g., which is included in a SCG failure information message, to T-MN 503. In operation 517, T-MN 503 may transfer the SCG failure related information to S-MN 502. If the SCG failure related information is received before the timer is expired, S-MN 502 can understand that the SHR and the SCG failure related information are for the same PCell change with PSCell change procedure, i.e., in operation 518, S-MN 502 can correlate the SHR and the SCG failure related information.

Optionally, in operation 513A, S-MN 502 may transfer the SHR to S-SN 504. In operation 514A, S-SN 504 may start a timer (e.g., timer duration may equal to Tstore_UE_cntxt) upon receiving the SHR. In operation 517A, S-MN 502 may transfer the SCG failure related information to S-SN 504. In operation 518A, S-SN 504 may determine that the SHR and the SCG failure related information are related to the same PCell change with PSCell change procedure, if the SCG failure related information is received before the timer is expired, i.e., S-SN 504 can correlate the SHR and the SPC-Report.

### Embodiment 1-2-2

When trigger condition(s) for a SHR is met (e.g., before T304 for target PCell is stopped or expired), a UE further checks whether trigger condition(s) for a SPC-Report is met, e.g., before T304 for target PSCell is stopped or until T304 for target PSCell is expired. There may be following sub-embodiments in Embodiment 1-2-2.
(1) In an embodiment, if trigger condition(s) for SPC-Report is met before T304 for target PSCell is stopped (i.e., RA to target PSCell is successful):
   a) the UE may send the SHR together with SPC-Report to the network node (e.g., target MN), when PCell change with PSCell change is successful (i.e., after both T304 for target PCell and T304 for target PSCell are stopped). For example, the SHR and SPC-Report are sent to the network node in one RRC message in a cascaded way or a parallel way (if so, the SHR and the SPC-Report may be two separate reports, or the SPC report is a part of the SHR), or the SHR and SPC-Report are sent to the network node in two RRC messages separately (if so, the SHR and the SPC-Report may be two separate reports); or
   b) the UE may release the stored SHR or successful PCell change related information (e.g., VarSuccessHO-Report), and also releases the stored SPC-Report or successful PSCell change related information (e.g., VarSPC-Report), when an RA to target PCell fails (i.e., T304 for target PCell is expired).
(2) In a further embodiment, if trigger condition(s) for SPC-Report is not met before T304 for target PSCell is stopped:
   a) the UE may only send the SHR or successful PCell change related information (e.g., VarSuccessHO-Report) to the network node (e.g., T-MN), when PCell change with PSCell change is successful; or
   b) the UE may release the stored SHR or successful PCell change related information (e.g., VarSuccessHO-Report), when an RA to target PCell fails (i.e., T304 for target PCell is expired).
(3) In another embodiment, if trigger condition(s) for SPC-Report is not met until T304 for target PSCell is expired, i.e., an RA to PSCell fails (since T304 for target PSCell is expired), but an RA to target PCell succeeds:
   a) Option X: the UE may release the stored SHR or successful PCell change related information (e.g., VarSuccessHO-Report). The UE sends SCG failure related information to T-MN.
   b) Option Y: the UE may send the stored successful PCell change related information (e.g., stored SHR) together with SCG failure related information to T-MN. If needed, T-MN sends the successful PCell change related information together with SCG failure related information to S-MN.
(4) In yet another embodiment, if trigger condition(s) for SPC-Report is not met until T304 for target PSCell is expired, i.e., RA to PSCell fails (since T304 for target PSCell is expired), and RA to target PCell fails:
   a) the UE may release the stored SHR or successful PCell change related information (e.g., VarSuccessHO-Report). Optionally, the UE may send failed PCell change related information together with SCG failure related information in a RLF report to network.
(5) In yet another embodiment, if trigger condition(s) for SPC-Report is met but RA to PSCell fails (i.e. T304 for target PSCell is expired):
   a) the UE may only send the stored successful PCell change related information (e.g. stored SHR) to the network node (e.g., target MN), when RA to target PCell is successful, the stored SPC-Report if any is released.

### Embodiment 1-2-3

The UE firstly performs an RA to target PSCell, SPC-Report if generated is released, when RA to target PCell fails and/or RA to target PSCell fails. If trigger condition(s) for SPC-Report is met and the UE successfully access to the target PSCell (i.e., T304 for target PSCell is stopped), the UE further checks whether RA to target PCell is successful and/or whether trigger condition(s) for SHR is met. There may be following sub-embodiments in Embodiment 1-2-3.
(1) In an embodiment, if trigger condition(s) for SHR is met but an RA to target PCell fails, i.e., PCell change fails, the UE may release the stored PSCell change related information or the SPC-Report (e.g., VarSPC-Report). Also, the UE may release the stored PCell change related information or the SHR (e.g., VarSuccessHO-Report).
(2) In a further embodiment, if trigger condition(s) for SHR is not met and RA to target PCell fails i.e., PCell change fails, the UE may release the stored PSCell change related information or the SPC-Report (e.g., VarSPC-Report).
(3) In another embodiment, if trigger condition(s) for SHR is met and RA to target PCell is successful, the UE may send SHR together with the SPC-Report to a network node (e.g., T-MN), for example, the SHR and SPC-Report are sent to the network node in one RRC message in a cascaded way or a parallel way (if so, the SHR and the SPC-Report may be two separate reports, or the SPC report is a part of the SHR), or, the SHR and SPC-Report are sent to the network node in two RRC messages separately (if so, the SHR and the SPC-Report may be two separate reports).
(4) In yet another embodiment, if trigger condition(s) for SHR is not met and RA to target PCell is successful, the UE sends SPC-Report to the network node (e.g., T-MN).

In some embodiments of the present application, a new procedure is introduced for storing or reporting successful PCell change with PSCell change related information.

To enable a network node to provide configuration for storing or reporting successful PCell change with PSCell change, these embodiments introduce a UE's capability for storing or reporting information related to successful PCell change with PSCell change. Regarding the optional UE capability, there may be following two options in different embodiments:
(1) Option A: Optional with capability signalling. Storing or reporting successful PCell change with PSCell change related information is optional, even if a UE supports PCell change with PSCell change mechanism. This capability may be explicitly signalled by the UE to a network node, i.e., introducing the optional UE capability with signalling for storing or reporting a report including information regarding a successful completion of a PCell change with PSCell change procedure (e.g., which may be named as “a successful PCell change with PSCell change report” or the like). For instance, an optional UE capability indication for storing or reporting successful PCell change with PSCell change related information is included in UECapabilityInformation message.
(2) Option B: Optional without capability signalling. Storing or reporting successful PCell change with PSCell change related information is optional, and no explicit capability bit is signalled by the UE.

In some embodiments of the present application, configuration(s) for storing or reporting successful PCell change with PSCell change may be sent to the UE by S-MN. Configuration(s) for storing or reporting successful PCell change with PSCell change may include one set of trigger condition(s) associated with MCG for triggering a successful PCell change with PSCell change report (e.g., at least including T310 related threshold for source PCell, T312 related threshold associated with the measurement identity of the target PCell, or T304 related threshold for target PCell), and another set of trigger condition(s) associated with SCG for triggering the successful PCell change with PSCell change report (e.g., at least including T310 related threshold for source PSCell, T312 related threshold associated with the measurement identity of the target PSCell, or T304 related threshold for target PSCell). There may be following sub-embodiments in these embodiments.
(1) In an embodiment, S-MN may configure one set of trigger condition(s) associated with MCG for triggering a successful PCell change with PSCell change report. For example, S-MN may configure T310 related threshold for source PCell or T312 related threshold associated with the measurement identity of the target PCell, and T-MN may configure T304 related threshold for target PCell.
(2) In a further embodiment, if it is S-MN to configure one set of trigger condition(s) associated with SCG for triggering a successful PCell change with PSCell change report. For example, S-MN may configure T310 related threshold for source PSCell or T312 related threshold associated with the measurement identity of the target PSCell, similar as Solution 1 in Embodiment 1-1, S-MN needs to know that T-MN triggers PSCell change or T-MN needs to indicate that T310/T312 related threshold needs to be configured. For instance, an indication may be included in the HO Request ACK message (out of the Transparent Container for HO/PCell change), to indicate the source MN to configure T310 related threshold for source PSCell or T312 related threshold associated with the measurement identity of the target PSCell.
   a) For an example, one common trigger threshold (e.g., only one trigger threshold or two separate trigger thresholds having different IE names but the same value) can be configured for both T310 related threshold for source PSCell and T310 related threshold for source PCell, and the UE is indicated explicitly or implicitly (e.g., with different IE names). For example, an explicit indication is included in the RRC message to let the UE know that the common trigger threshold is configured for both T310 related threshold for source PSCell to trigger a successful PCell change with PSCell change report and T310 related threshold for source PCell to trigger a successful PCell change with PSCell change report, i.e., an explicit indication for indicating that the common trigger threshold is configured for both “the set of trigger conditions associated with the MCG for triggering a successful PCell change with PSCell change report” and “the set of trigger conditions associated with the SCG for triggering a successful PCell change with PSCell change report”. Another way is that one threshold “x” configured as T310 related threshold for source PSCell (e.g., thresholdPercentageT310for SuccessfulPCellChange WithPSCellChangeReport or thresholdPercentageT310ofPCell) as well v as another threshold “x” configured as T310 related threshold for source PSCell (e.g., thresholdPercentageT310for SuccessfulPCellChange WithPSCellChangeReport or thresholdPercentageT310ofPSCell) can be included in the RRC message to be sent to the UE, i.e., an implicit indication for indicating that the two trigger thresholds are configured for “the set of trigger conditions associated with the MCG for triggering a successful PCell change with PSCell change report” and “the set of trigger conditions associated with the SCG for triggering a successful PCell change with PSCell change report”
   b) For a further example, one common trigger threshold (e.g. only one trigger threshold or two separate trigger thresholds having different IE names but same value) can be configured for both T312 related threshold associated with the measurement identity of the target PSCell and T312 related threshold associated with the measurement identity of the target PCell, and the UE is indicated explicitly or implicitly (e.g., with different IE names). For example, an explicit or implicit indication is included in the RRC message to let the UE know that the common trigger threshold is configured for both T312 related threshold associated with the measurement identity of the target PSCell to trigger a successful PCell change with PSCell change report and T312 related threshold associated with the measurement identity of the target PCell to trigger a successful PCell change with PSCell change report, i.e., an explicit indication for indicating that the common trigger threshold is configured for both “the set of trigger conditions associated with the MCG for triggering a successful PCell change with PSCell change report” and “the set of trigger conditions associated with the SCG for triggering a successful PCell change with PSCell change report”. Another way is that one threshold “y” configured as T312 related threshold associated with the measurement identity of the target PSCell (e.g., thresholdPercentageT312for SuccessfulPCellChange WithPSCellChangeReport or thresholdPercentageT312ofPSCell) as well as another threshold “y” configured as T312 related threshold associated with the measurement identity of the target PCell (e.g., thresholdPercentageT312for SuccessfulPCellChange WithPSCellChangeReport or thresholdPercentageT312ofPCell) can be included in the RRC message to be sent to the UE, i.e., an implicit indication for indicating that the two trigger thresholds are configured for “the set of trigger conditions associated with the MCG for triggering a successful PCell change with PSCell change report” and “the set of trigger conditions associated with the SCG for triggering a successful PCell change with PSCell change report”.
   c) For another example, different trigger thresholds can be configured for T310 related threshold for source PSCell and T310 related threshold for source PCell separately, with different IE names. For example, the different IE names in the RRC message implicitly indicates to the UE that different trigger thresholds are configured for T310 related threshold for source PSCell and T310 related threshold for source PCell separately, i.e., an implicit indication for indicating that different trigger thresholds are configured for “the set of trigger conditions associated with the MCG for triggering a successful PCell change with PSCell change report” and “the set of trigger conditions associated with the SCG for triggering a successful PCell change with PSCell change report”.
   d) For an additional example, different trigger thresholds can be configured for T312 related threshold associated with the measurement identity of the target PSCell and T312 related threshold associated with the measurement identity of the target PCell separately, with different IE names. For example, the different IE names in the RRC message implicitly indicates to the UE that different trigger thresholds are configured for T312 related threshold associated with the measurement identity of the target PSCell and T312 related threshold associated with the measurement identity of the target PCell separately, i.e., an implicit indication for indicating that different trigger thresholds are configured for “the set of trigger conditions associated with the MCG for triggering a successful PCell change with PSCell change report” and “the set of trigger conditions associated with the SCG for triggering a successful PCell change with PSCell change report”.
(3) In another embodiment, if it is T-MN to configure one set of trigger condition(s) associated with SCG for triggering a successful PCell change with PSCell change report. For example, T-MN may configure T310 related threshold for source PSCell or T312 related threshold associated with the measurement identity of the target PSCell, T310 related threshold for source PSCell or T312 related threshold associated with the measurement identity of the target PSCell is included in the HO Request ACK message (in or out of the Transparent Container for HO/PCell change).
(4) In yet another embodiment, if it is S-SN to configure one set of trigger condition(s) associated with SCG for triggering a successful PCell change with PSCell change report. For example, S-SN may T310 related threshold for source PSCell or T312 related threshold associated with the measurement identity of the target PSCell. In this embodiment, T-MN indicates S-MN that one set of trigger condition(s) associated with SCG for triggering a successful PCell change with PSCell change report needs to be configured, and then, S-MN indicates S-SN that one set of trigger condition(s) associated with SCG for triggering a successful PCell change with PSCell change report needs to be configured. For instance, an indication may be included in the HO Request ACK message (out of the Transparent Container for HO/PCell change), to indicate that S-MN T310/T312 related threshold for triggering a successful PCell change with PSCell change report is needed. Or, an indication may be included in the SN Release Request message or the SgNB Release Request message, to indicate the source SN to configure T310 related threshold for source PSCell or T312 related threshold associated with the measurement identity of the target PSCell for triggering a successful PCell change with PSCell change report. T310 related threshold for source PSCell or T312 related threshold associated with the measurement identity of the target PSCell can be included in the SN Release Request ACK message or the SgNB Release Request ACK message.
(5) In an additional embodiment, one set of trigger condition(s) associated with SCG for triggering a successful PCell change with PSCell change report, e.g., T304 related threshold for target PSCell, is generated by T-SN, i.e., T304 related threshold for target PSCell is included in SN Addition Request ACK message or the SgNB Addition Request ACK message and Handover Request ACK message (in or out of the Transparent Container for HO/PCell change).

In some embodiments of the present application, when at least one condition within the set of trigger condition(s) associated with MCG for triggering a successful PCell change with PSCell change report, and at least one condition within the set of trigger condition(s) associated with SCG for triggering a successful PCell change with PSCell change report are fulfilled, a UE may generate or store successful PCell change with PSCell change related information or the successful PCell change with PSCell change report. Optionally, a network node indicates the UE explicitly or implicitly about how to trigger or generate the successful PCell change with PSCell change report. For example, an indication may be sent to the UE, to indicate that the UE only generate or store the successful PCell change with PSCell change report when at least one condition within the set of trigger condition(s) associated with MCG for triggering a successful PCell change with PSCell change report and at least one condition within the set of trigger condition(s) associated with SCG for triggering a successful PCell change with PSCell change report are fulfilled.

In some embodiments of the present application, a UE only sends the stored successful PCell change with PSCell change report to a network node when the PCell change with PSCell change procedure is successful. In particular:
(1) First, the UE sends an indication for availability of a successful PCell change with PSCell change report to a network node (e.g., T-MN), e.g., via a RRC Reconfiguration/Setup/Resume/Re-establishment Complete message;
(2) Then, the network node (e.g., T-MN) may transmit a request (e.g., a UE information request message) message to the UE, for requesting the successful PCell change with PSCell change report or the successful PCell change with PSCell change related information.
(3) After receiving the request, the UE may transmit the stored information related with a successful PCell change with PSCell change procedure or a successful PCell change with PSCell change report or successful PCell change with PSCell change related information to the network node (e.g., T-MN), e.g., via a UE information response message.
(4) The successful PCell change with PSCell change report or successful PCell change with PSCell change related information or information related with a successful PCell change with PSCell change procedure may at least include:
   a) Information associated with source SpCell, e.g., cell information of source PCell, cell information of source PSCell, measurement results of source PCell and/or source PSCell when the RRC message for PCell change with PSCell change is received or PCell change with PSCell change procedure is successfully performed. In this disclosure, cell information includes global cell identity and tracking area code of the cell, or PCI and frequency information (e.g., ARFCN).
   b) Information associated with target SpCell, e.g., cell information of target PCell, cell information of target PSCell, measurement results of target PCell and/or target PSCell when the RRC message for PCell change with PSCell change is received or PCell change with PSCell change procedure is successfully performed. In this disclosure, cell information includes global cell identity and tracking area code of the cell, or PCI and frequency information (e.g., ARFCN).
   c) Cause value of successful PCell change with PSCell change report, e.g., trigger conditions associated with the MCG and SCG are fulfilled, or T310/T312/T304 related threshold is fulfilled.
   d) RA information towards target PCell and/or target PSCell, e.g., RACH configurations including time and/or frequency resources for a RA procedure.

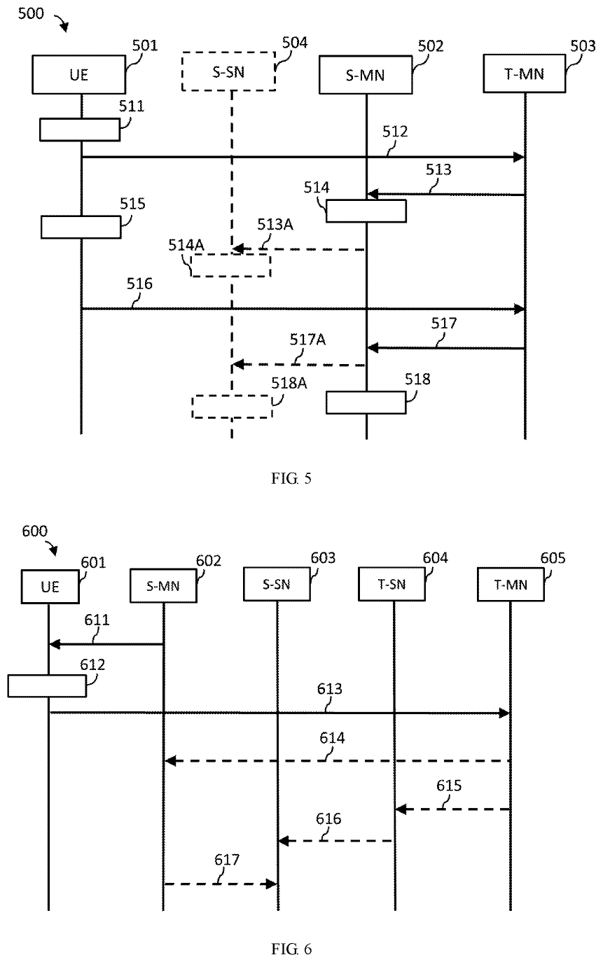

In some embodiments of the present application, the successful PCell change with PSCell change report may be transferred to T-SN and/or S-MN and/or S-SN directly or indirectly by the receiving network node which receives the successful PCell change with PSCell change report from the UE (e.g., T-MN). For example, T-MN may transfer the successful PCell change with PSCell change report to the S-MN; T-MN may transfer the successful PCell change with PSCell change report to the T-SN; S-MN may transfer the successful PCell change with PSCell change report to the S-SN; and/or, T-SN may transfer the successful PCell change with PSCell change report to S-SN. The node which receives the successful PCell change with PSCell change report may perform MRO analysis and update configuration related to the PCell change with PSCell change procedure.
(1) In an embodiment, when T-MN receives a successful PCell change with PSCell change report, T-MN may transfer the successful PCell change with PSCell change report to S-MN. S-MN may analyze the successful PCell change with PSCell change report and/or decide whether/how to modify parameters related to the PCell change with PSCell change procedure, for example, for the case that successful PCell change with PSCell change report is triggered due to fulfillment of “S-MN configured T310 related threshold for source PCell” and “S-MN configured T310 related threshold for source PSCell”.
(2) In a further embodiment, when T-MN receives successful PCell change with PSCell change report, T-MN may transfer the successful PCell change with PSCell change report to S-MN. T-MN may also transfer the successful PCell change with PSCell change report to T-SN. S-MN and T-SN may analyze the successful PCell change with PSCell change report and/or decide whether/how to modify parameters related to the PCell change with PSCell change procedure, for example, for the case that successful PCell change with PSCell change report is triggered due to fulfillment of “S-MN configured T312 related threshold associated with the measurement identity of the target PCell” and “T-SN configured T304 related threshold for target PSCell”. A specific example is described in the embodiments of FIG. 6 as follows.

FIG. 6 illustrates an exemplary flowchart of transmitting a report including information regarding a successful completion of a PCell change with PSCell change procedure in accordance with some embodiments of the present application. Details described in all other embodiments of the present application are applicable for the embodiments shown in FIG. 6. It should be appreciated by persons skilled in the art that the sequence of the operations in exemplary procedure 600 in FIG. 6 may be changed and some of the operations in exemplary procedure 600 in FIG. 6 may be eliminated or modified, without departing from the spirit and scope of the disclosure.

Specifically, in the exemplary flowchart 600 as shown in FIG. 6, in operation 611, UE 601 may receive an RRC reconfiguration message (which includes configuration(s) for storing or reporting successful PCell change with PSCell change related information) from S-MN 602. In operation 612, UE 601 may store or generate a successful PCell change with PSCell change report. In operation 613, UE 601 may transmit the successful PCell change with PSCell change report to T-MN 605. T-MN 605 may analyze the successful PCell change with PSCell change report and/or decide whether/how to modify parameters related to the PCell change with PSCell change procedure.

After operation 613, only a part of operations 614-617 are performed in some embodiments, which all of operations 614-617 are performed in some other embodiments. For instance, there may be following options in different embodiments of FIG. 6, i.e., Options (1)-(4) as below. It should be contemplated that other options may also implement the embodiments shown in FIG. 6, without departing from the spirit and scope of the disclosure.
Option (1): in operation 614, T-MN 605 may transfer the received successful PCell change with PSCell change report to S-MN 602. S-MN 602 may analyze the successful PCell change with PSCell change report and/or decide whether/how to modify parameters related to the PCell change with PSCell change procedure.
Option (2): in operation 614, T-MN 605 may transfer the received successful PCell change with PSCell change report to S-MN 602. In operation 615, T-MN 605 may transfer the received successful PCell change with PSCell change report to T-SN 604. S-MN 602 and/or T-SN 604 may analyze the successful PCell change with PSCell change report and/or decide whether/how to modify parameters related to the PCell change with PSCell change procedure.
Option (3): after operation 614, S-MN 602 may transfer the received successful PCell change with PSCell change report to S-SN 603 in operation 617. Then, S-SN 603 may analyze the successful PCell change with PSCell change report and/or decide whether/how to modify parameters related to the PCell change with PSCell change procedure.
Option (4): after operation 615, T-SN 604 may transfer the received successful PCell change with PSCell change report to S-SN 603 in operation 616. Then, S-SN 603 may analyze the successful PCell change with PSCell change report and/or decide whether/how to modify parameters related to the PCell change with PSCell change procedure.

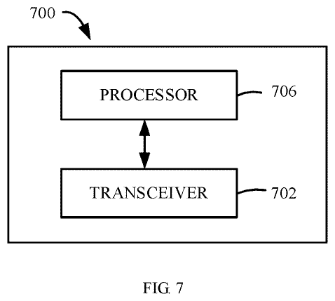

FIG. 7 illustrates a block diagram of an exemplary apparatus 700 in accordance with some embodiments of the present disclosure. As shown in FIG. 9, the apparatus 700 may include at least one processor 706 and at least one transceiver 702 coupled to the processor 706. Although in this figure, elements such as the at least one transceiver 702 and processor 706 are described in the singular, the plural is contemplated unless a limitation to the singular is explicitly stated. In some embodiments of the subject application, the transceiver 702 may be divided into two devices, such as a receiving circuitry and a transmitting circuitry. In some embodiments of the subject application, the apparatus 700 may further include an input device, a memory, and/or other components.

In some embodiments of the subject application, the apparatus 700 may be a UE or a network node (e.g., S-SN, S-MN, T-SN, and/or T-MN). The transceiver 702 and the processor 706 may interact with each other so as to perform the operations with respect to the UE or the network node described above, for example, in any of FIGS. 1-6.

In some embodiments of the subject application, the apparatus 700 may further include at least one non-transitory computer-readable medium. For example, in some embodiments of the present disclosure, the non-transitory computer-readable medium may have stored thereon computer-executable instructions to cause the processor 706 to implement the method with respect to a UE or a network node (e.g., S-SN, S-MN, T-SN, and/or T-MN) as described above. For example, the computer-executable instructions, when executed, cause the processor 706 interacting with transceiver 702 to perform the operations with respect to the UE or the network node described in FIGS. 1-6.

Those having ordinary skill in the art would understand that the operations or steps of a method described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. Additionally, in some aspects, the operations or steps of a method may reside as one or any combination or set of codes and/or instructions on a non-transitory computer-readable medium, which may be incorporated into a computer program product.

In this document, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” and the like, as used herein, are defined as “including”. Expressions such as “A and/or B” or “at least one of A and B” may include any and all combinations of words enumerated along with the expression. For instance, the expression “A and/or B” or “at least one of A and B” may include A, B, or both A and B. The wording “the first,” “the second” or the like is only used to clearly illustrate the embodiments of the subject application, but is not used to limit the substance of the subject application.

1. A network node (NN) for wireless communication, comprising:
at least one memory; and
at least one processor coupled with the at least one memory and configured to cause the NN to:
transmit, to a user equipment (UE), a configuration for storing or reporting one of a successful handover report (SHR) and a successful primary secondary cell (PSCell) change (SPC) report, or a first report including information of a successful completion of a primary cell (PCell) change with a PSCell change procedure; and
wherein the configuration includes at least one of a first configuration for a set of trigger conditions associated with a master cell group (MCG), or a second configuration for a set of trigger conditions associated with a secondary cell group (SCG).

2. The NN of claim 1, wherein the configuration includes at least one of:
one or more common trigger thresholds configured for both the set of trigger conditions associated with the MCG and the set of trigger conditions associated with the SCG; or
one or more trigger thresholds configured separately for the set of trigger conditions associated with the MCG and the set of trigger conditions associated with the SCG.

3. The NN of claim 1, wherein the at least one processor is configured to cause the NN to receive, from a target node, a first indication that the second configuration for the set of trigger conditions associated with the SCG needs to be configured.

4. The NN of claim 3, wherein the at least one processor is configured to cause the NN to at least one of:
generate the second configuration for the set of trigger conditions associated with the SCG; or
transmit, to a secondary node (SN), a second indication that the SN needs to configure the second configuration for the set of trigger conditions associated with the SCG.

5. The NN of claim 1, wherein the at least one processor is configured to cause the NN to receive, from a target node, at least one of:
a cell radio network temporary identifier (C-RNTI) of a target PCell;
an indication for indicating that the SHR and the SPC report are related to a same PCell change with PSCell change procedure; or
first time information related to at least one of the SHR or the SPC report.

6. The NN of claim 1, wherein the at least one processor is configured to cause the NN to receive, via at least one of:
a cell radio network temporary identifier (C-RNTI) of a target PCell;
an indication that the SHR and SCG failure information are related to a same PCell change with the PSCell change procedure; or
second time information related to at least one of the SHR or the SCG failure information.

7. A network node (NN) for wireless communication, comprising:
at least one memory; and
at least one processor coupled with the at least one memory and configured to cause the NN to at least one of:
transmit, to a source node, a configuration for storing or reporting at least one of a successful primary secondary cell (PSCell) change (SPC) report, or a first report including information of a successful completion of a primary cell (PCell) change with a PSCell change procedure; and wherein the configuration includes a first configuration for a set of trigger conditions associated with a secondary cell group (SCG); or
transmit, to the source node, a first indication that the first configuration for the set of trigger conditions associated with the SCG needs to be configured.

8. The NN of claim 7, wherein the configuration further includes a second configuration for a set of trigger conditions associated with a master cell group (MCG), and wherein a second configuration is used for storing or reporting at least one of a successful handover report (SHR), or the first report.

9. The NN of claim 8, wherein the at least one processor is configured to cause the NN to transmit, via at least one of:
a cell radio network temporary identifier (C-RNTI) of a target PCell;
an indication that the SHR and the SPC report are related to a same PCell change with the PSCell change procedure; or
first time information related to at least one of the SHR or the SPC report.

10. The NN of claim 8, wherein the at least one processor is configured to cause the NN to transmit at least one of:
a cell radio network temporary identifier (C-RNTI) of a target PCell;
an indication that the SHR and SCG failure information are related to a same PCell change with the PSCell change procedure; or
second time information related to at least one of the SHR or the SCG failure information.

11. A user equipment (UE) for wireless communication, comprising:
at least one memory; and
at least one processor coupled with the at least one memory and configured to cause the UE to:
receive, from a network node (NN), a configuration storing or reporting one of a successful handover report (SHR) and a successful primary secondary cell (PSCell) change (SPC) report, or a first report including information of a successful completion of a primary cell (PCell) change with a PSCell change procedure; and
wherein the configuration includes at least one of a first configuration for a set of trigger conditions associated with a master cell group (MCG), or a second configuration for a set of trigger conditions associated with a secondary cell group (SCG).

12. The UE of claim 11, wherein the at least one processor is configured to cause the UE to:
in response to at least one trigger condition for the SHR being fulfilled before fulfillment of at least one trigger condition for the SPC report, transmit the SHR or check whether the at least one trigger condition for the SPC report is fulfilled before transmitting the SHR; and
in response to the at least one trigger condition for the SPC report being fulfilled before fulfillment of the at least one trigger condition for the SHR report, check whether the at least one trigger condition for the SHR is fulfilled before transmitting the SPC report.

13. The UE of claim 12, wherein, in response to transmitting the SHR, the at least one processor is configured to cause the UE to store in the SPC report upon fulfillment of the at least one trigger condition for the SPC report, at least one of:
a cell radio network temporary identifier (C-RNTI) of a target PCell;
an indication that the SHR and the SPC report are related to a same PCell change with the PSCell change procedure; or
first time information related to at least one of the SHR or the SPC report.

14. The UE of claim 12, wherein, in response to checking whether the at least one trigger condition for the SPC report is fulfilled before transmitting the SHR, the at least one processor is configured to cause the UE to one of:
transmit the SHR together with the SPC report, in response to fulfillment of the at least one trigger condition for the SPC report and in response to the successful completion of the PCell change with the PSCell change procedure; or
only transmit the SHR, in response to unfulfillment of the at least one trigger condition for the SPC report and in response to the successful completion of the PCell change with the PSCell change procedure.

15. The UE of claim 11, wherein the at least one processor is configured to store information of the successful completion of the PCell change with the PSCell change procedure in the first report, in response to fulfillment of at least one trigger condition within the set of trigger conditions associated with the MCG and fulfillment of at least one trigger condition within the set of trigger conditions associated with the SCG.

16. A method performed by a user equipment (UE), the method comprising:
receiving, from a network node (NN), a configuration storing or reporting one of a successful handover report (SHR) and a successful primary secondary cell (PSCell) change (SPC) report, or a first report including information of a successful completion of a primary cell (PCell) change with a PSCell change procedure; and
wherein the configuration includes at least one of a first configuration for a set of trigger conditions associated with a master cell group (MCG), or a second configuration for a set of trigger conditions associated with a secondary cell group (SCG).

17. The method of claim 16, further comprising:
in response to at least one trigger condition for the SHR being fulfilled before fulfillment of at least one trigger condition for the SPC report, transmitting the SHR or checking whether the at least one trigger condition for the SPC report is fulfilled before transmitting the SHR; and
in response to the at least one trigger condition for the SPC report being fulfilled before fulfillment of the at least one trigger condition for the SHR report, checking whether the at least one trigger condition for the SHR is fulfilled before transmitting the SPC report.

18. The method of claim 17, wherein, in response to transmitting the SHR, the method further comprising storing in the SPC report upon fulfillment of the at least one trigger condition for the SPC report, at least one of:
a cell radio network temporary identifier (C-RNTI) of a target PCell;
an indication that the SHR and the SPC report are related to a same PCell change with the PSCell change procedure; or
first time information related to at least one of the SHR or the SPC report.

19. The method of claim 17, wherein, in response to checking whether the at least one trigger condition for the SPC report is fulfilled before transmitting the SHR, the method further comprising:
transmitting the SHR together with the SPC report, in response to fulfillment of the at least one trigger condition for the SPC report and in response to the successful completion of the PCell change with the PSCell change procedure; or
only transmitting the SHR, in response to unfulfillment of the at least one trigger condition for the SPC report and in response to the successful completion of the PCell change with the PSCell change procedure.

20. The method of claim 16, further comprising storing information of the successful completion of the PCell change with the PSCell change procedure in the first report, in response to fulfillment of at least one trigger condition within the set of trigger conditions associated with the MCG and fulfillment of at least one trigger condition within the set of trigger conditions associated with the SCG.
